(19) United States
(12) Patent Application Publication
(10) Pub. No.: US 2025/0326240 A1
(43) Pub. Date: Oct. 23, 2025

(54) DRY POWDER SCREEN PRINTING

(71) Applicant: Sakuu Corporation, San Jose, CA (US)

(72) Inventors: Karl Littau, Los Altos Hills, CA (US); Zhi Qiao, San Jose, CA (US); Steven Zhichao Shi, Santa Clara, CA (US)

(73) Assignee: Sakuu Corporation, San Jose, CA (US)

(21) Appl. No.: 19/254,887

(22) Filed: Jun. 30, 2025

Related U.S. Application Data
(60) Provisional application No. 63/820,906, filed on Jun. 10, 2025.

(51) Int. Cl. B41M 1/12; H01M 4/04

(52) U.S. Cl. CPC B41M 1/12; H01M 4/0414

(57) ABSTRACT

Systems, methods, and other embodiments associated with high speed, high precision direct deposition of patterned dry powder. In one embodiment, an example apparatus includes a patterning device and a powder delivery system delivering dry powder onto an interior surface of the patterning device. The interior surface of the patterning device is configured to include a screen having top and bottom surfaces and a plurality of openings positioned between the top and bottom surfaces, whereby each opening is configured to contain a portion of the received dry powder. The bottom surface of the screen forming the exterior surface of the patterning device. The interior surface includes a blade configured to be positioned adjacent to the interior surface of the screen to force the portion of dry powder through the interior surface and into a corresponding opening of the screen thereby patterning each portion of dry powder.

### CROSS REFERENCE TO THE RELATED APPLICATIONS

This application is related to the pending U.S. patent application Ser. No. 18/391,024, filed on Dec. 20, 2023, and entitled “Electrode Fabrication Process”, the entire contents of which are incorporated herein by reference. This application is further related to the pending U.S. patent application Ser. No. 19/072,702, filed on Mar. 6, 2025, and entitled “Intermediate Surface to Substrate Powder Transfer System and Method”, the entire contents of which are incorporated herein by reference. This application is further related to the pending U.S. Patent Application No. 19/, filed on Jun. 30, 2025, and entitled “Dry Powder Offset Printing”, the entire contents of which are incorporated herein by reference.

### TECHNICAL FIELD

The embodiments generally relate to material deposition systems and material patterning systems that can include powder printing systems, powder deposition systems, 3D printing systems, and additive manufacturing machines and systems. In particular, the embodiments generally relate to apparatus, methods, and systems for processing dry material such as powder into a pattern and transferring the patterned dry powder directly onto a target substrate (e.g., a conveyed substrate) using dry powder screen printing and/or dry powder stencil printing.

### BACKGROUND

In present powder deposition systems, powder is deposited from a hopper onto a substrate. The deposited powder is non-uniform and can require several iterative smoothing or conditioning processes which in turn requires adjustment and control of powder deposition from the hopper to minimize powder non-uniformities. The direct deposition of a uniform dry patterned powder onto a substrate can reduce the need for additional powder processing for manufacturing a product. Generally, precise control and high-speed deposition of dry powder, particularly patterned powder, can be challenging using current material dispensers found in powder printing systems, 3D Printing systems, and additive manufacturing machines and systems. The current process requires the powder to be extensively engineered to achieve free-flowing behavior for deposition, which significantly limits the range of materials that can be used for such applications. One problem with current material dispensers, as implemented with conveyed substrates, involves the use of a hopper or a feeder which dispenses material such as dry powder as a nonuniform powder pile. The powder pile dispensed onto the substrate by the hopper may require further smoothing and conditioning to obtain a uniform and smooth surface. Once the powder surface is smoothed out and uniform on the substrate, it may then be patterned. In order to improve deposition speed and powder surface uniformity, the hopper/feeder surface geometries, surface coating, agitation, and dispensing mechanism may be adjusted to obtain a consistent powder mass flow rate for the powder pile. However, the powder can often still require further smoothing and conditioning to obtain a uniform powder layer for patterning and compaction at a calender stage. Another problem with the above material dispenser includes the lack of precise control of powder deposited at high speeds as it is mechanically agitated/actuated to be transferred onto the substrate which tends to result in non-uniform powder deposition. Further, while consistent powder mass flow rate is desirable and can aide in downstream powder processing such as smoothing and compaction of the dry powder, the lack of depositing patternable powder can limit the shape, features, feature sizes, and other qualities of the deposited powder. A problem with material dispensers, as implemented with build platforms (e.g., powder bed systems or binder jetting 3D printing system), involves the use of a recoater, a roller, a blade or a horizontal bar to deposit powder particles which tend to have larger particle sizes leading to thick layers and rough surfaces, which limits the feature sizes and printing resolution and may also create large voids which prevent full densification during sintering processes. Moreover, the process of depositing a layer, patterning the layer with binder, and curing the binder can be a slow and time-consuming process for manufacturing a product. Therefore, there is a need for a dry powder printing system and method that can print various dry powder materials, and provide precise control, uniformity, feature size, speed, shapes, and other qualities for depositing a patterned powder. Moreover, there is a need for a simpler design that can reduce or eliminate the need for multiple smoothing rollers, conditioning rollers, complicated hopper configurations, and various energy sources for facilitating controlled, precise, or high-speed powder deposition.

### SUMMARY

In an implementation, an apparatus including a patterning device including an interior surface and an exterior surface opposite to the interior surface, the interior surface configured to receive dry powder, the exterior surface positioned adjacent to an upper surface of a target substrate; and a powder delivery system communicably coupled with the patterning device to deliver dry powder onto the interior surface of the patterning device; the interior surface of the patterning device comprising: a screen comprising a top and bottom surface and a plurality of openings positioned between the top and bottom surfaces, each opening of the plurality of openings configured to contain a portion of the received dry powder, and a blade configured to be positioned adjacent to the top surface of the screen to force the portion of dry powder through the top surface of a corresponding opening of the screen and into the corresponding opening thereby patterning each portion of dry powder.

In another implementation, a method including depositing dry powder onto an interior surface of a patterning device; positioning an upper surface of a target substrate to be adjacent to an exterior surface of the patterning device, the exterior surface being opposite to the interior surface; patterning portions of the deposited dry powder within the interior surface of the patterning device, wherein patterning each portion of deposited dry powder comprises: positioning dry powder on a screen, the screen comprising a top and bottom surface and a plurality of openings positioned between the top and bottom surfaces, each opening of the plurality of openings configured to receive a portion of the received dry powder, forcing each portion of dry powder through the top surface of a corresponding opening of the screen and into the corresponding opening thereby patterning each portion of dry powder; and transferring to the upper surface of the target substrate at least one patterned portion of dry powder contained in the corresponding opening of the screen as a patterned dry powder layer.

### BRIEF DESCRIPTION OF THE DRAWINGS

The accompanying drawings, which are incorporated in and constitute a part of the specification, illustrate various systems, apparatus, methods, and one or more implementations of the disclosure. It will be appreciated that the illustrated element boundaries (e.g., boxes, groups of boxes, or other shapes) in the figures represent one implementation of the boundaries. In some implementations one element may be implemented as multiple elements or that multiple elements may be implemented as one element. In some implementations, an element shown as an internal component of another element may be implemented as an external component and vice versa. Furthermore, elements may not be drawn to scale. The drawing figures depict one or more implementations in accord with the present teachings, by way of example only, not by way of limitation. It is to be understood that the drawings are designed for the purpose of illustration only and not as a definition of the limits of the present disclosure. In the figures, like reference numerals refer to the same or similar elements. Furthermore, it should be understood that the drawings are not necessarily to scale. A complete understanding of the present implementations and the advantages and features thereof will be more readily understood by reference to the following detailed description when considered in conjunction with the accompanying drawings wherein:

FIG. 1A illustrates one embodiment of a screen and stencil patterning system for high speed, high precision deposition of patterned dry powder directly onto a target substrate, in accordance with aspects of the present disclosure;

FIG. 1B illustrates one embodiment of a screen patterning system for high speed, high precision deposition of patterned dry powder directly onto a target substrate, in accordance with aspects of the present disclosure;

FIG. 1C illustrates one embodiment of a screen and stencil patterning system for high speed, high precision deposition of patterned dry powder directly onto a target substrate, in accordance with aspects of the present disclosure;

FIG. 1D illustrates one embodiment of a screen and stencil patterning system that may be implemented in a patterning system for high speed, high precision deposition of patterned dry powder directly onto a target substrate, in accordance with aspects of the present disclosure;

FIG. 1E illustrates a cross-sectional view along line A1-A1 extending vertically downwards from the top surface of the screen of FIG. 1D for high speed, high precision deposition of patterned dry powder directly onto a target substrate, in accordance with aspects of the present disclosure;

FIG. 1F illustrates one embodiment of a screen patterning system with grid shaped non-woven screen that may be implemented in a patterning system for high speed, high precision deposition of patterned dry powder directly onto a target substrate, in accordance with aspects of the present disclosure;

FIG. 1G illustrates a cross-sectional view along line A2-A2 extending vertically downwards from the top surface of the screen of FIG. 1F for high speed, high precision deposition of patterned dry powder directly onto a target substrate, in accordance with aspects of the present disclosure;

FIG. 1H illustrates one embodiment of a screen patterning system with funnel shaped wire mesh structure that may be implemented in a patterning system for high speed, high precision deposition of patterned dry powder directly onto a target substrate, in accordance with aspects of the present disclosure;

FIG. 1I illustrates a cross-sectional view along line A3-A3 extending vertically downwards from the top surface of the screen of FIG. 1H for high speed, high precision deposition of patterned dry powder directly onto a target substrate, in accordance with aspects of the present disclosure;

FIG. 1J illustrates one embodiment of a screen patterning system with conic shaped wire mesh structure that may be implemented in a patterning system for high speed, high precision deposition of patterned dry powder directly onto a target substrate, in accordance with aspects of the present disclosure;

FIG. 1K illustrates a cross-sectional view along line A4-A4 extending vertically downwards from the top surface of the screen of FIG. 1J for high speed, high precision deposition of patterned dry powder directly onto a target substrate, in accordance with aspects of the present disclosure;

FIG. 2 illustrates one embodiment of a screen patterning system with one or more powder conditioning devices for high speed, high precision deposition of patterned dry powder directly onto a target substrate, in accordance with aspects of the present disclosure;

FIG. 3A illustrates one embodiment of a screen and stencil patterning system implemented as a rotating body with one or more powder conditioning devices for high speed, high precision deposition of patterned dry powder directly onto a target substrate, in accordance with aspects of the present disclosure;

FIG. 3B illustrates one embodiment of a screen patterning system implemented as a rotating body with one or more powder conditioning devices for high speed, high precision deposition of patterned dry powder directly onto a target substrate, in accordance with aspects of the present disclosure;

FIG. 4 illustrates one embodiment of a screen patterning system with a powder barrier for high speed, high precision deposition of patterned dry powder directly onto a target substrate, in accordance with aspects of the present disclosure;

FIG. 5 illustrates one embodiment of a screen patterning system with a powder shield for high speed, high precision deposition of patterned dry powder directly onto a target substrate, in accordance with aspects of the present disclosure;

FIG. 6 illustrates one embodiment of a screen and stencil patterning system with flow apertures for high speed, high precision deposition of patterned dry powder directly onto a target substrate, in accordance with aspects of the present disclosure;

FIG. 7 illustrates one embodiment of a screen and stencil patterning system with retaining apertures for high speed, high precision deposition of patterned dry powder directly onto a target substrate, in accordance with aspects of the present disclosure;

FIG. 8 illustrates one embodiment of a screen patterning system with an example screen holding mechanism for high speed, high precision deposition of patterned dry powder directly onto a target substrate, in accordance with aspects of the present disclosure;

FIG. 9 illustrates one embodiment of a screen patterning system with an example screen and substrate holding mechanism for high speed, high precision deposition of patterned dry powder directly onto a target substrate, in accordance with aspects of the present disclosure;

FIG. 10A illustrates one embodiment of a screen patterning system with an example substrate holding mechanism for high speed, high precision deposition of patterned dry powder directly onto a target substrate, in accordance with aspects of the present disclosure;

FIG. 10B illustrates one embodiment of a screen patterning system with an example substrate holding mechanism for high speed, high precision deposition of patterned dry powder directly onto a target substrate, in accordance with aspects of the present disclosure;

FIG. 10C illustrates one embodiment of a screen patterning system with an example substrate holding mechanism for high speed, high precision deposition of patterned dry powder directly onto a target substrate, in accordance with aspects of the present disclosure; and

FIG. 11 illustrates one embodiment of a flowchart depicting a process for facilitating high speed, high precision deposition of patterned dry powder directly onto a target substrate with precise control of powder size, shape, and uniformity, in accordance with aspects of the present disclosure.

### DETAILED DESCRIPTION

Systems and methods are described herein as associated with dry powder patterning, and dry powder deposition for facilitating high speed, high precision deposition of patterned dry powder directly onto a target substrate with precise control of powder feature size, shape, uniformity, improved powder deposition speed, and other qualities and features as described herein for depositing a patterned powder. Current powder deposition systems and methods for battery manufacturing include a powder bed system and a conveyor/roll system can often lead to nonuniform powder deposition and lack of precise control of powder feature sizes, shapes, uniformity, improved powder deposition speed, and other qualities. For example, in the powder bed system (i.e., binder jetting 3D printing system), powder is deposited using a build platform. The current process requires the powder to be extensively engineered to achieve free-flowing behavior for deposition, which significantly limits the range of materials that can be used for such applications. Moreover, the process of depositing a layer, patterning the layer with a binder, and curing the binder can be a slow and time-consuming process for manufacturing a product. As another example, the powder deposition in conveyor/roll systems typically involves the use of a hopper or a feeder which dispenses material such as dry powder as a nonuniform powder pile. In order to improve deposition speed and powder surface uniformity, the hopper/feeder surface geometries, surface coating, agitation, and dispensing mechanism may be adjusted to obtain a consistent powder mass flow rate for the powder pile. However, the powder can often still require further smoothing and conditioning to obtain a uniform powder layer for patterning and compaction at a calender stage. Further, the material dispenser can lack precise control of powder deposited at high speeds as powder is mechanically agitated/actuated to be transferred onto the substrate, which tends to result in non-uniform powder deposition.

The present disclosure solves these problems and others using a dry powder screen printing system that receives dry powder directly on a screen of the printing system and a target substrate that receives dry powder directly from the screen. The screen-printing system includes a patterning system to pattern dry powder and a transfer means to transfer the patterned dry powder to a target substrate. The powder may be deposited as a patterned powder onto the target substrate. The dry powder may be received onto the target substrate using a screen, screen and stencil configuration. The screen printing system may include conditioning systems and a directed energy system to facilitate and/or perform flow of the powder and/or separation of powder from the screen or stencil. The directed energy may be spatially and temporally modulated thereby separating a patterned dry powder from the screen (or the screen-printing system) to the target substrate. Moreover, the dry powder may also be conditioned or treated on the screen as needed. The screen surfaces may be cleaned and pre-/post-conditioned prior to receiving dry powder for transfer to the target substrate. The screen or stencil interior and exterior surfaces may be coated or conditioned/treated to facilitate and/or perform adhesion (or separation) of dry powder to the target substrate. The powder may be conditioned/treated on the target substrate to activate a binder, adhere the powder to the target substrate, and facilitate adhesion and/or cohesiveness of the dry powder. Other benefits and advantages of the screen-printing system are described herein. Moreover, the speed or rate of screen printing, screen and stencil printing, or rotary screen/stencil printing may be adjusted as desired. For example, the speed may be adjusted to lower speeds to facilitate stationary (low speed) printing.

### Screen or Stencil Printing Apparatus

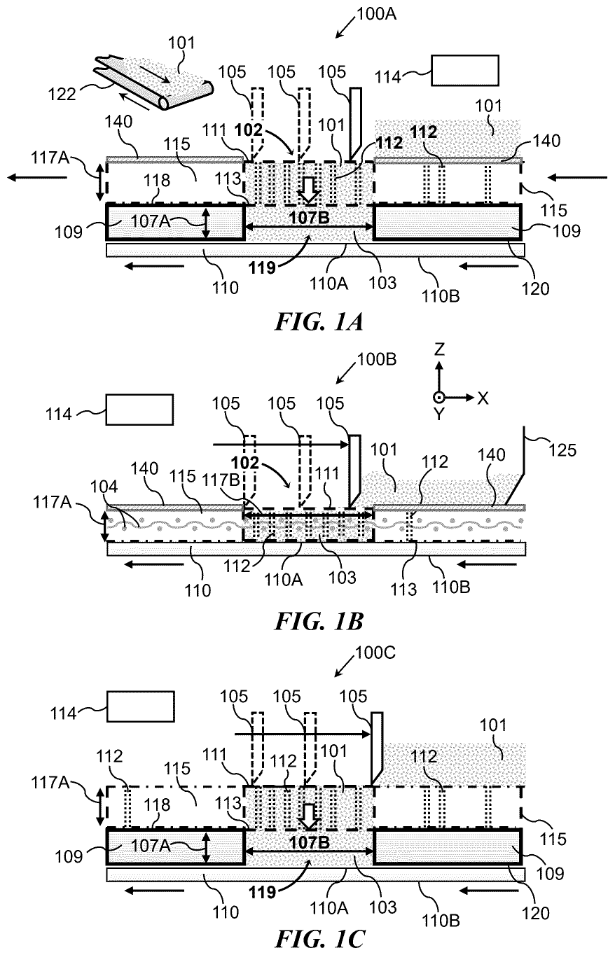

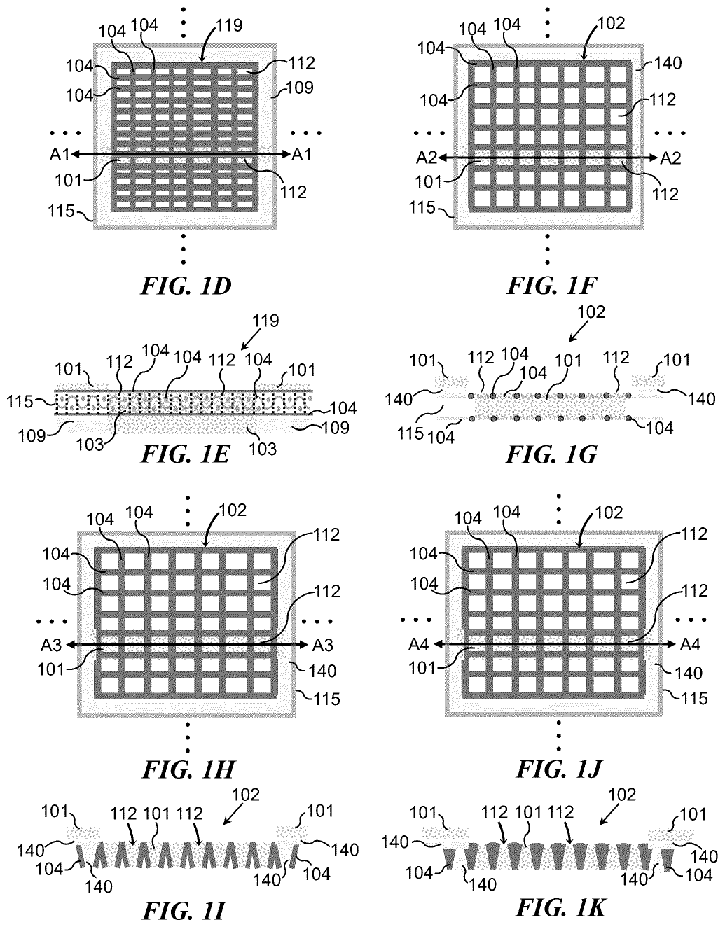

FIG. 1A illustrates one embodiment of a screen and stencil patterning device or patterning system for high speed, high precision deposition of patterned dry powder directly onto a target substrate, in accordance with aspects of the present disclosure. In some implementations, the patterning system 100A may include a controller 114, a blade 105, a stencil 109 with a top surface 118 and a bottom surface 120 and one or more stencil openings 119, a screen 115 with a top surface 111 and a bottom surface 113 and a plurality of screen openings 112 positioned between the top and bottom surfaces for receiving and containing dry powder 101 and passing dry powder to the stencil opening partition 119 defined by the stencil 109. In various implementations, one or more screen openings 112 may be sealed, coated, covered, or blocked to prevent dry powder 101 from flowing through the top surface 111 and/or the bottom surface 113 of the screen 115. Moreover, the dry powder pattern may be defined by one or more areas of the screen 115 whereby dry powder is contained in the screen and allowed to flow through the top surface 111 and the bottom surface 113 of the screen. Each of the plurality of screen openings or screen mesh holes defines the smallest patterning feature as the two-dimensional pixel or three-dimensional voxel. The stencil opening or pattern opening defines the patterning area comprising a plurality of the screen openings. With reference to FIGS. 1A-1C, a portion of the screen 115 is shown, the portion of the screen 115 may include one stencil opening 119 defined by the stencil 109 or one pattern opening 102 defined by the powder blocking layer 140. In various implementations, dry powder is received on an interior surface (or transfer surface) of the patterning system. The patterning system is brought into contact with an upper surface of a target substrate. The patterning system draws or scrapes dry powder across a screen/stencil configuration. The screen/stencil configuration receives and confines the dry powder on the upper surface of the target substrate and within the screen/stencil configuration. The patterning system is then removed or lifted from the target substrate to transfer/print the patterned powder on the upper surface of the target substrate. The target substrate may then be conveyed, and the process can be repeated.

Referring again to FIG. 1A, in certain embodiments, the screen openings 112 may be sealed, coated, covered, or blocked by a powder blocking layer 140 (e.g., an emulsion layer, plate, or other rigid material). In certain embodiments, the powder blocking layer 140 may be an emulsion layer positioned on the top surface 111, on bottom surface 113 of the screen 115, or throughout the screen 115 to prevent powder from flowing through the screen 115. In some implementations, the emulsion layer may be positioned between the top surface 111 and the bottom surface 113. In certain implementations, the emulsion layer may be positioned on the top surface 111 or on the bottom surface 113 and between the top surface 111 and bottom surface 113. The powder blocking layer 140 may be configured to define the borders or boundaries of a pattern opening 102. Further, in some implementations, a plate, stencil 109, or other rigid material may be positioned on the bottom surface 113 of the screen 115 thereby acting as a powder blocking layer and preventing dry powder 101 from flowing through the bottom surface 113 of the screen 115.

In a further aspect of the disclosure, in many implementations, at least one of: the pattern openings 102, the screen openings 112, and the stencil openings 119, or any combinations thereof may be configured to define the pattern for the received dry powder 101. Further, the dry powder 101 may be patterned into patterned powder 103 and transferred to a target substrate 110. Further, the thickness of a plate, stencil 109, or other rigid material when positioned on the bottom surface 113 of the screen 115 can increase the spacing between the screen 115 and the target substrate 110. The increased spacing allows more dry powder 101 to pass through the screen 115 to be patterned and thereby adds to the thickness of the patterned dry powder 103 to be transferred to the target substrate 110 positioned below the patterning system 100A.

Further, a powder deposition system 122 may be coupled to the patterning system 100A for depositing dry powder 101 onto an interior surface of the patterning system 100A, that is, onto the top surface 111 of the screen 115 and/or onto the top surface 118 of a stencil 109. In one implementation, the powder deposition system 122 may be a conveyor belt. In alternate implementations, the powder deposition system 122 may be a vibratory trough conveyor, a fluidized powder pipe conveyor, or an auger. The powder deposition system 122 may deliver the powder to a single, centralized location on the screen interior surface or use a distribution device to distribute the powder across a region of the screen top surface. In certain embodiments, the top surface 111 of the screen 115 may form the interior surface of the patterning system 100A, and the bottom surface 113 of the screen 115 may form the exterior surface of the patterning system 100A. Similarly, in certain embodiments, the top surface 118 of the stencil 109 may form the interior surface of the patterning system 100A, and the bottom surface 120 of the stencil 109 may form the exterior surface of the patterning system 100A. The patterning system 100A may implement one or more blades 105, stencils 109, screens 115, or any combinations thereof, to directly print: dry powder onto a substrate, electrode powder for batteries, or electrode powder/layers for lithium-ion batteries, for example. The uniformity of the patterned dry powder 103 transferred to the target substrate 110 may be defined by the shape, dimensions, and properties of the screen 115 (e.g., pattern openings 102 and screen holes 112) and/or stencil 109 (e.g., stencil openings 119) as described herein. In many implementations, screen printing as described herein can replace the need for a rough substrate for transferring dry powder. Moreover, the powder thickness control can be achieved by using a screen 115 or stencil 109 of different thicknesses, dimensions, and configurations as described herein. The screen 115 may be constructed of woven or nonwoven wires. Alternatively, the screen may be formed from a perforated film, foil, or sheet. The screen may also be formed from electroformed metal meshes such as electroformed nickel mesh.

With reference to FIGS. 1A-1B, in many implementations, screen openings 112 within the top surface 111 and the bottom surface 113 of the screen 115 may contain the deposited dry powder 101 whereby a force or pressure can then be applied to the screen 115, for example, the top surface 111 of the screen 115 to move the dry powder 101 through the screen openings 112. In one embodiment, the dry powder 101 may be contained and patterned within screen openings 112 and transferred onto an upper surface 110A of a target substrate 110 (as shown in FIGS. 1I, 1K, and 6-7, for example). In certain embodiments, the dry powder 101 may be forced through screen openings 112 into a stencil opening 119, patterned by the stencil opening 119 into a patterned dry powder 103, then transferred onto an upper surface 110A of a target substrate 110. As described herein, the patterning of the dry powder 103 may be performed by the screen 115 and/or the stencil 109 while the properties of the pattern such as dimensions, shape, and uniformity may be defined by the various openings, for example, pattern opening 102, screen opening 112, stencil opening 119, as well as conditioning devices/energetic devices which can determine the amount of dry powder 101 that may pass through the screen 115. In many implementations, the position and shape of the pattern openings 102 defined by the powder blocking layer 140 and/or the position and shape of the stencil openings 119 defined by the stencil 109 may determine the shape and position of the patterned powder 103 to be received on a target substate 110. The stencil thickness 107A and the screen thickness 117A from the patterning device to the target substrate 110 may add to the thickness of the patterned powder 103.

In some implementations, the patterning system may include a screen 115 and powder blocking layer 140 configuration whereby the pattern may be defined by the position and shape of the pattern opening 102, defined by the pattern blocking layer 140, and the screen thickness 117A. In certain implementations, the patterning system may include a screen and stencil configuration whereby the pattern may be defined by position, shape, and properties of the screen 115 as well as the position, shape, and properties of each stencil opening 119. Further, the pattern thickness may be defined by the screen thickness 117A and the stencil thickness 107A. In various implementations, the blade 105 presses on the screen 115 to move the bottom surface 113 of the screen 115 to a minimum distance 117C from the upper surface of 110A of the target substrate 110 such that the bottom surface 113 contacts the upper surface 110A of the target substrate 110. The minimum distance 117C may be configured to be between 0.05 um to 20 um. Further, in various implementations, the screen thickness 117A and stencil thickness 107A may be in a range of between 10 um to 500 um. In various implementations, the screen length 117B (i.e., the pattern opening 102) and stencil length 107B of the stencil opening 119 may be in range of between 10 mm to 1000 mm. In some implementations, one or more stencil openings 119 and/or pattern openings 102 may be arranged substantially adjacent to one another along one or more portions of the patterning system 100A.

Referring to FIG. 1B, in many implementations, the screen 115 may be defined by the arrangement and configuration of one or more layers of wire mesh lines 104. In one implementation, the screen 115 may be defined as a grid of wire mesh lines 104 that may form the top surface 111 and the bottom surface 113 of the screen 115. In some implementations, screen openings 112 may be formed between intersecting or overlapping wire mesh lines 104 (e.g., as shown in FIGS. 1D and 1E). The dry powder 101 may flow into pattern openings 102 (i.e., screen regions absent of a powder blocking layer) and between intersecting or overlapping wire mesh lines 104 (i.e., screen openings 112). In certain implementations, the patterning system 100B may include one or more pattern openings 102, each pattern opening 102 comprising a plurality of screen openings 112 and configured to allow dry powder 101 to flow into and through one or more layers of the wire mesh lines 104 and onto an upper surface 110A of the target substrate. The dry powder 101 may be patterned by the pattern opening 102 as defined by the pattern blocking layer 140, for example, taking the shape and dimensions of the pattern opening 102 as defined by the pattern blocking layer 140. In many implementations, the screen 115 is brought into direct contact with the target substrate 110, the blade 105 is made to scrape across the top surface 111 of the screen 115 and force the patterned dry powder 103 onto the upper surface 110A of the target substrate 110,

### Screen, Stencil, and Pattern Openings for Receiving Deposited Material

In a further aspect of the disclosure, the patterning system 100A may include one or more powder blocking layers 140 located on the top surface 111/bottom surface 113 of the screen 115 and configured to include one or more pattern openings 102. In some implementations, the powder blocking layer 140 may be positioned between the top surface 111 and the bottom surface 113. In certain implementations, the powder blocking layer may be positioned on the top surface 111 or on the bottom surface 113 and between the top surface 111 and the bottom surface 113. The pattern openings 102 are positioned over a plurality of screen openings 112. Each screen opening 112 may be positioned between the pattern opening 112 and the stencil 109 and configured to contain and move the received dry powder 101 to a substrate or a stencil opening 119. In some implementations, the dry powder 101 may pass through each screen opening 112 and into the stencil opening 119 to be transferred to the target substrate 110. The patterning system 100A may further include one or more stencil openings 119 for containing and patterning dry powder 101 passed from screen openings 112. In one embodiment, each stencil opening 119 may be positioned to vertically align with each pattern opening 102. In some implementations, the stencil opening 119 may be horizontally offset from the pattern opening 102 as needed to direct powder during separation of the patterned powder 103 from the stencil opening 119. Moreover, one or more interior surfaces of the stencil opening 119 may be angled as needed to further direct powder during separation of a patterned powder 103 from the stencil opening 119.

In a further aspect of the disclosure, a stencil opening 119 may be configured to contain and pattern dry powder 101 forced through screen openings 112 and into the stencil opening 119 by a blade 105, for example. In various implementations, one or more portions of the screen 115 (e.g., one or more screen openings 112) may be sealed, coated, covered, or blocked by a powder blocking layer 140 (e.g., an emulsion layer, plate, or other rigid material). The powder blocking layer 140 may be an emulsion layer positioned on the top surface 111 or the bottom surface 113 of the screen 115 to prevent dry powder 101 from flowing through the top surface 111 and/or out of the screen 115. Further, the powder blocking layer 140 may be configured to define the borders or boundaries of the pattern opening 102. In many implementations, a stencil 109 (e.g., a plate or other rigid material) may be positioned on the bottom surface 113 of the screen 115 thereby acting as a powder blocking layer and preventing dry powder 101 from flowing through the bottom surface 113 of the screen 115. Therefore, in certain implementations, the shape, dimensions, and properties of the stencil opening 119 may define the pattern of dry powder transferred to the target substrate. A stencil 109 when positioned on the bottom surface 113 of the screen 115 can increase the spacing between the bottom surface 113 of the screen 115 and target substrate 110 allowing more dry powder 101 to pass through the screen 115 and thereby adding to the thickness of the patterned dry powder 103.

In one implementation, the patterned dry powder 103 transferred to the target substrate 110 may be patterned based on a combination of size and shape of the pattern openings 102, screen openings 112, and stencil openings 119. In some implementations, the patterning system 100A may include a plurality of stencil openings 119, whereby each stencil opening 119 or a subset of stencil openings 119 can be configured to have different dimensions as needed to provide one or more distinct patterned dry powder 103 layers as desired. In many implementations, as described in detail herein, each pattern opening 102 may vertically align with each stencil openings 119. In certain embodiments, a pattern opening 102 may be defined by the dimensions of the powder blocking layer 140 whereby the powder blocking layer 140 may be positioned on the top surface 111 of the screen 115 or extend between the top surface 111 and the bottom surface 113 of the screen 115. As an example, the patterned powder 103 transferred to the target substrate 110 may be defined by the pattern opening 102 and the stencil opening 119. Moreover, one or more coatings or layers may be positioned between the powder blocking layer 140 and the stencil 109 (or stencil opening 119) to increase the thickness of the patterned powder 103, minimize vibration or agitation of the screen 115/stencil 109, and/or facilitate adhesion of the powder blocking layer 140 and stencil 109 over extended periods of usage, as an example. Further, screen openings 112 and pattern openings 102 may be configured to receive and pattern the dry powder 101 or receive and pass the dry powder 101 to the stencil opening 119 for patterning.

### Surface Features, Coatings, and Topography

In some implementations, the top surface 111 of the screen 115, the top surface 118 of the stencil 109, pattern openings 102, and one or more stencil openings 119, or any combination thereof, may be coated to inhibit powder adhesion or powder accumulation within the interior surfaces of the patterning system 100A to facilitate control and direction of deposited dry powder 101 into pattern openings 102, screen openings 112, or stencil openings 119 for patterning. In one embodiment, the coating may be a polymer, a thin metal/alloy layer, or a ceramic layer.

Moreover, in certain implementations, the surface topography of one or more regions of the interior surface of the patterning system 100A may be adjusted, for example, but not limited to, roughened, polished, or smoothed, as needed to facilitate a desired level of friction for flowable dry powder 101. Further, the surface topography of the exterior surface of the patterning system 100A may be adjusted as needed to facilitate a desired level of friction during transfer and contact of the flowable dry powder 101 (i.e., separation of patterned powder 103 from the patterning system) to the target substrate 110 and/or contact of the exterior surface of the patterning system 100 with the target substrate 110 (e.g., current collector web). In some implementations, the exterior surface of the patterning system 100A (i.e., the stencil bottom surface 120 or the screen bottom surface 113) may be brought into direct contact with the upper surface 110A of the target substrate 110. In some implementations, the exterior surface of the patterning system 100A may be positioned directly above and in contact with the upper surface 110A of the target substrate 110. In one implementation, the top surfaces 111 of the screen 115, the interior surface of the patterning system 100A may be roughened to facilitate friction of received dry powder 101. In one implementation, the exterior surface of the patterning system 100A (i.e., the stencil bottom surface 120 or the screen bottom surface 113) may be configured to be smooth to facilitate reduced friction to the patterned dry powder 103 during separation of the patterned powder 103 and transfer onto the target substrate 110. In certain implementations, the exterior surface of the patterning system 100A (i.e., the stencil bottom surface 120 or the screen bottom surface 113) may be smooth to reduce stress and pressure on the target substrate 110 due to friction during contact of the upper surface 110A of the target substrate 110 with the exterior surface of the patterning system 100A. In some implementations, the screen comprises a top surface and a bottom surface, wherein the top surface and bottom surface have different surface roughness.

### Screen Pattern and Stencil Combination

With reference to FIGS. 1A and 1C, in one implementation, the shapes and dimensions of the screen openings 112 and pattern openings 102 may be configured as needed to define the volume or mass of dry powder 101 to be received into the stencil opening 109. The shape and dimension of the stencil opening 109 may be configured for defining the pattern transferred to the target substrate 110. In certain embodiments, the bottom surface 113 of the screen 115 may be configured to define the exterior surface of the patterning system 100A, while the top surface 111 of the screen 115 may be configured to define the interior surface of the patterning system 100A. In some implementations, the dimensions of the screen 115 and optional blocking layer 140 may be configured as needed to define the shape, thickness, and uniformity of the patterned dry powder 103 transferred on the target substrate 110. In certain embodiments, the patterning system 100A may include a stencil 109 with one or more stencil openings 119 for patterning the dry powder 101, in place of, or in addition to, the screen 115. In some implementations, the stencil 109 may be positioned on the bottom surface 113 of the screen 115 to prevent powder 101 or patterned dry powder 103 from passing through the screen 115. The stencil 109 when positioned on the screen 115 may define the exterior surface of the patterning system 100A or the patterning system 100C. In many implementations, one or more stencil openings 119 may be positioned along the exterior surface of the patterning system 100A to define the pattern, shape, thickness, and uniformity of the patterned dry powder 103 allowed to transfer to the target substrate 110. The target substrate 110 and patterning system 100A (e.g., screen 115 and/or stencil 109) can be placed in direct contact with one another such that the patterned dry powder 103 may be transferred directly onto the upper surface 110A of the target substrate 110. Further, in some implementations, the screen 115 may be formed as a single sheet or single piece (i.e., a spherical or cylindrical sheet for rotary screens). Similarly, the stencil 109 may be formed as a single sheet or single piece (i.e., spherical or cylindrical stencil) and configured to completely encapsulate the screen 115.

In some embodiments, the patterning system 100A may be configured to include a plurality of screens 115 and/or a plurality of stencils 109 arranged throughout the exterior surfaces of the patterning system 100A. The arrangement of the plurality of screens 115 and the plurality of stencils 109 may further include pairings of pattern openings 102 or stencil openings 119 to facilitate formation of a desired patterned dry powder layer. As an example, a pairing of a pattern opening 102 and a stencil opening 119 may be aligned (or open) to allow patterned dry powder 103 to transfer to the target substrate 110. Conversely, a pairing of a pattern opening 102 and a stencil opening 119 may be offset (or closed) to prevent dry powder 101 from flowing out of the screen 115 and/or exterior surface of the patterning system 100A. An open pairing may be configured such that the screen openings 112 below the pattern opening 102 vertically align with the stencil opening 119 thereby allowing dry powder 101 to flow into the stencil opening 119 and transfer onto the target substrate 110. A closed pairing may be configured such that the screen openings 112 below the pattern opening 102 do not vertically align with the stencil opening 119 thereby preventing dry powder 101 from flowing into the stencil opening 119 and transferring onto the target substrate 110. In some implementations, the patterning system 100A may include a plurality of screens 115 (or wire mesh lines 104) and/or a plurality of stencils 119 stacked or positioned over one another to facilitate or restrict powder mass flow for complex patterning, for example, layer or tiers of dry powder 101. As described above, the stack of screens 115 (or wire mesh lines 104) and/or stencils 119 may be positioned such that pattern openings 102 and stencil openings 119 do not overlap to restrict flow of dry powder 101. Further, the stack of screens 115 (or wire mesh lines 104) and/or stencils 119 may be positioned such that pattern openings 102 and stencil opening 119 overlap to allow dry powder 101 to flow into a stencil opening 119 and onto the target substrate 110.

As can be readily contemplated, the components of the patterning system of the disclosure may include a number of configurations. For example, the patterning system may be configured to include one or more blades 105 (e.g., squeegees, rollers, etc.,), stencils 109, screens 115, pattern openings 102, stencil openings 119, and wire mesh lines 104 or wire mesh line 104 patterns, or any combinations thereof, positioned on the interior surface of the patterning system and spaced apart from one another to create one or more desired patterns or powder mass flow rates for the received dry powder 101. Additionally, in some implementations, a plurality of screens 115 (wire mesh lines 104) may be layered and spaced apart vertically from one another to control the mass flow rate of received dry powder 101 into a target stencil opening 119 or target screen openings 112 for forming a patterned dry powder 103 and transferring the patterned dry powder 103 onto a target substrate 110.

### Screen Pattern Configuration

FIG. 1B illustrates one embodiment of a screen patterning system for high speed, high precision deposition of patterned dry powder directly onto a target substrate, in accordance with aspects of the present disclosure. In some implementations, the patterning system 100B may include a blade 105, a barrier 125, a screen 115 with a top surface 111 and a bottom surface 113, a plurality of screen openings 112 positioned between the top surface 111 and a bottom surface 113 for receiving and containing dry powder 101, and a blocking layer 140 which aids in defining the pattern by limiting the transfer of powder to specified regions. In many embodiments, the received dry powder 101 may be contained and patterned directly into a patterned dry powder 103 by configuring the properties of the screen 115 and blocking layer 140 (e.g., shapes, dimensions, coatings, opening dimensions, etc.,). The patterned dry powder 103 may then be transferred directly to a target substrate 110 from the bottom surface 113 of the screen 115. In some implementations, the patterning system 100B may include a barrier 125 configured to be spaced apart from and adjacent to the blade 105. In some implementations, the target substrate 110 may be conveyed in a longitudinal direction, and the screen 115 may be configured to move in the same longitudinal direction as the conveyed target substrate 110. Further, the barrier 125 may be configured to be stationary with respect to the moving screen 115 to restrict received powder 101 between an exterior surface of the blade 105 adjacent to and opposite from an exterior surface of the barrier 125 facing the blade 105. In some implementations, the barrier 125 may be configured to be stationary with respect to the blade 105 to define a fixed volume of received dry powder 101.

In certain implementations, the screen 115 may include a plurality of woven or nonwoven wire mesh lines 104 configured to extend between the terminating edges of the screen 115. In one embodiment, the plurality of wire mesh lines 104 may extend at perpendicular angles to form a grid of wire mesh lines 104. The grid may include a plurality of screen openings 112, each screen opening 112 positioned between a pair of adjacent rows and columns of wire mesh lines 104. Further, each screen opening 112 may be defined as a unit for containing and transferring dry powder 101 to a surface or another opening, for example, a target substrate 110 (as shown in FIG. 1B) or a stencil opening 119 (as shown in FIG. 1A), or another pattern opening 102, and so forth. In various implementations, the screen 115 or stencil 109 (i.e., stencil opening 119) is placed in proximity or in contact with the target substrate 110, dry powder 101 is drawn across the interior surface of the screen 115/stencil 109 by a blade 105 (e.g., squeegee) with sufficient force, vibration, or other actuation to facilitate powder to be transferred through the screen 115 and to force intimate contact between the screen 115/stencil 109 and the target substrate 110.

In a further aspect of the disclosure, in some implementations, the patterning system may receive material (e.g., dry powder) from the powder deposition system 122 and direct each portion of the deposited material through one or more pattern openings 102 and into defined screen openings 112 corresponding to each pattern opening 102. Each screen opening 112 (and pattern opening 102) may be arranged as desired to form distinct patterns or arrangements for defining the patterned dry powder 103. That is, in some embodiments, the properties of the patterned dry powder 103 (e.g., surface uniformity, shape, thickness, cohesiveness, flowability, etc.,) may be facilitated by the number of pattern openings 102 (i.e., defined by the powder blocking layer 140) and the properties of each screen opening 112. Further, the number of pattern openings 102 (i.e., defined by the powder blocking layer 140) and parameters for each screen opening 112 may be configured as desired to facilitate continuous transfer of patterned dry powder 103 onto the target substrate 110.

Moreover, the screen opening 112 may have various shapes and sizes. In some implementations, the screen opening 112 may be circular in shape and configured to have a diameter in a range of between 10 um to 200 um. In various implementations, the shape of the screen opening 112 may be cylindrical, square, hexagonal, or rectangular. The spacings between the screen openings 112 may be similar or different to facilitate surface uniformity, thickness, cohesiveness, or flowability of the patterned dry powder 103. The parameters of each stencil opening 119, pattern opening 102, and/or screen opening 112 may be configured as desired to facilitate flowability and/or cohesiveness of dry powder 101. In various implementations, the material of the screen 115 may be metal, metal alloy, stainless steel, polymers, or composites such as fiber composites, or the like. Further, in various implementations, the screen 115 may be made from electroformed metals such as nickel. In various implementations, the material of the blade 105 (or squeegee, roll, or the like) may be a hardened material or rigid material such as metal, metal alloy, stainless steel, polymer, or composites such as fiber composites, or the like to fully remove dry powder 101 from the top surface 111 of the screen 115 to minimize disruption of the printed dry powder 103 when the screen 115 is separated from the powder on the target substrate 110.

### Stencil Pattern and Screen Configuration

FIG. 1C illustrates one embodiment of a screen and stencil patterning system for high speed, high precision deposition of patterned dry powder directly onto a target substrate, in accordance with aspects of the present disclosure. In some implementations, the patterning system 100C may include a blade 105, a screen 115 having a top surface 111 and a bottom surface 113, and a stencil 109 with one or more stencil openings 119. The patterning system 100C includes a stencil 109 to block dry powder 101 from flowing through the bottom surface 113 of the screen 115 and bare screen 115 allowing dry powder 101 to freely flow over the top surface 111 of the screen 115. The screen 115 may be configured to include a plurality of screen openings 112 defined by the configuration of wire mesh lines 104. The screen openings 112 being positioned between the top surface 111 and the bottom surface 113 of the screen 115 and configured to receive and contain dry powder 101. In many implementations, the screen 109 may be configured to be a plate or other rigid material with one or more stencil openings 119 to pattern dry powder and allow patterned dry powder 103 to pass onto the upper surface of a target substrate 110. Further, the stencil 109 may be positioned on the bottom surface 113 of the screen 115 to block powder from flowing through the bottom surface 113 of the screen 115. In certain implementations, the thickness of the stencil 109 (i.e., stencil opening 119) may define the thickness of the patterned dry powder 103 formed within the stencil opening 119. Referring to FIG. 1C, the stencil openings 119 can increase the spacing between the screen 115 and target substrate 110 allowing more dry powder 101 to pass through the screen 115 and thereby adding thickness to the patterned dry powder 103 transferred to the target substrate 110 in contact with the patterning system 100C. In some implementations, the stencil 109 may be configured to have a smooth bottom surface 120 to facilitate powder separation during peeling off or separation from the target substrate 110. Further, in reference to FIGS. 1A-1C, the movement of the screen 115, blade 105, stencil 109, may be synchronized to facilitate stop and stamp/transfer (e.g., bringing the motion of the patterning system to a stop and pressing/forcing the patterned dry powder 103 through the screen 115/stencil 109 onto the target substrate). In some implementations, the screen 115, as defined by one or more layers of intersecting/overlapping wire mesh lines 104, may be configured to form a woven screen (i.e., woven wire mesh lines 104) or a non-woven screen (i.e., non-woven wire mesh lines 104, a grid, for example). In certain implementations, a perforated thin sheet of polymer or metal may be used in place of the screen 115. In various implementations, the screen openings 112 dimensions, wire mesh line 104 dimensions, and pattern opening 102 dimensions can be tailored to obtain uniform coverage of the patterned dry powder 103 on the target substrate 110. Typical screen openings 112 (e.g., apertures) may be configured to be larger than the largest particle size in the dry powder 101. In various implementations, the dimensions of the screen openings 112 can be defined to be in the range of 2 times to 50 times the average dry powder particle size. In some implementations, dimensions of the screen openings 112 may be defined to be in the range of between 2 times to 10 times the average dry powder particle size.

### Wire Mesh and Screen Patterns

FIGS. 1D-1K illustrate example embodiments of various screens that may be implemented in a patterning system for high speed, high precision deposition of patterned dry powder directly onto a target substrate, in accordance with aspects of the present disclosure. In FIGS. 1D-1K, a portion of the screen 115 is shown, the portion of the screen 115 including one stencil opening 119 defined by the stencil 109, or one pattern opening 102 defined by the powder blocking layer 140. To obtain a plurality of stencil openings 119 or pattern openings 102, such portions of the screen 115, as illustrated in FIGS. 1D-1K, that include a stencil opening 119 or pattern opening 102 may be replicated, spaced apart from one another, and placed in additional locations in the vertical and/or horizontal directions along the screen 115. In some implementations, the patterning system may be configured to include one or more layers of wire mesh lines 104 that define the screen 115. In a screen patterning system, each screen 115 may be configured to have one or more pattern openings 102 that may define the pattern of dry powder 101 transferred to the target substrate 110. The pattern openings 102 may be defined by the absence of a powder blocking layer(s) 140. In a screen and stencil patterning system, the screen 115 is covered or enclosed by a stencil 109. The stencil 109 may be configured to have one or more stencil openings 119 that may define the pattern of dry powder 101 transferred to the target substrate 110. The stencil 109 may define the one or more regions, surfaces, or areas of the screen 115 where powder is blocked from passing through the screen 115. Each pattern opening 102 surrounds one or more screen openings 112 formed between wire mesh lines 104. In some embodiments, each pattern opening 102 may be configured to have the same pattern of wire mesh lines 104 (i.e., the same number and configuration of screen openings 112). In some implementations, the patterning system may include one layer of wire mesh lines 104 that define the screen 115 and extend between the terminating edges of the screen 115. In certain implementations, the patterning system may be configured to include two or more layers of wire mesh lines 104 that define the screen and extend between the terminating edges of the screen 115. FIGS. 1D-1E illustrate one stencil opening 119 of a plurality of stencil openings in a screen and stencil patterning system. FIGS. 1F-1K illustrate one pattern opening 102 of a screen openings 112 defined by the pattern blocking layer 140 in a screen patterning system. FIGS. 1F-1G illustrate a screen 115 defined by two layers of wire mesh lines 104. Moreover, FIGS. 1H-1K illustrate a screen 115 defined by one layer of wire mesh lines 104. In many implementations, the patterning system may be configured to include a screen 115 defined by one layer of wire mesh lines 104 as illustrated in FIGS. 1B and 1E. It can be readily contemplated that the screen 115 of a patterning system can be configured to include one or more portions having a different number of layers of wire mesh lines 104 and/or one or more screen opening 112 configured to have the same or different patterning. In various implementations, one or more screen openings 112 may be sealed, coated, covered, or blocked by a powder blocking layer 140 (e.g., an emulsifier, plate, or other rigid material). The powder blocking layer 140 may be an emulsifier positioned on the top surface 111 or bottom surface 113 of the screen to prevent powder from flowing through the top surface 111. The powder blocking layer 140 may be configured to define the borders or boundaries of a plurality of pattern openings 102. In many implementations, a stencil 109 (e.g., a plate or other rigid material) may be positioned on the bottom surface 113 of the screen 115 thereby acting as a powder blocking layer and preventing dry powder 101 from flowing through the bottom surface 113 of the screen 115. The stencil opening 119 may define the pattern of dry powder to be transferred to a target substrate. The stencil thickness 107A can increase the spacing between the screen 115 and target substrate 110 allowing more dry powder 101 to pass through the screen 115 and thereby adding to the thickness to the dry powder 101 passed through the screen openings 112 to the target substrate 110 positioned below the patterning system.

With reference to FIGS. 1H-1I, the patterning system may be configured to include a screen 115 with one or more screen openings 112. Each screen opening 112 configured to include a plurality of funnel shaped screen openings 112 for retaining dry powder 101 between the top surface 111 and the bottom surface 113 of the screen 115, thereby enabling the formation of a flat powder bed during direct transfer onto the target substrate 110. With reference to FIGS. 1J-1K, the patterning system may be configured to include a screen 115 with one or more screen openings 112. Each screen opening 112 is configured to include a plurality of conical shaped screen openings 112 for directly transferring dry powder 101 between the top surface 111 and the bottom surface 113 to a target substrate 110.

### Controller and Movements

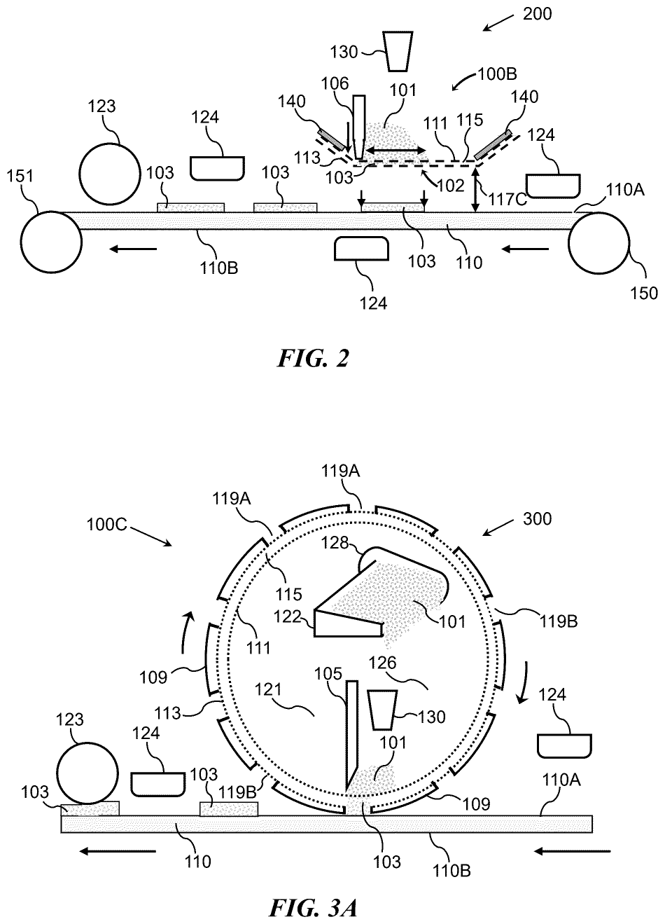

With reference to FIGS. 1A-1C and 2, for example, in various implementations, the motion of the screen 115 is configured to match the motion of the target substrate 110 such that the screen 115 and target substrate 110 are stationary relative to each other. In other words, the movement of the screen 115 and the target substrate 110 are matching, the screen 115 and target substrate 110 may be brought to a stop, the patterned dry powder 103 is transferred to the target substrate 110, and then the target substrate 110 and screen 115 are made to move again at the same velocity.

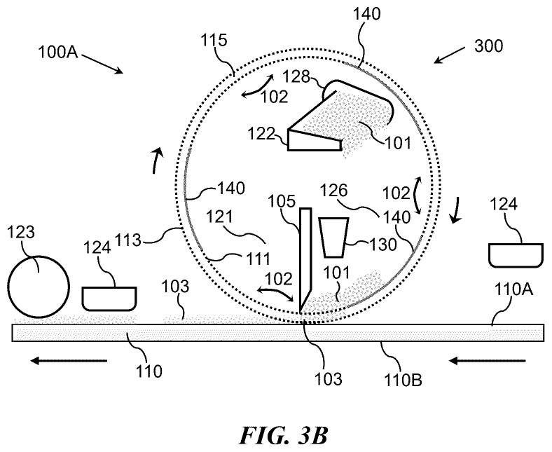

With reference to FIGS. 3A-3B and 4-7, for example, in various implementations, the motion of the screen 115 and the motion of the target substrate 110 are stationary relative to each other. In other words, when the screen 115 is in motion, the velocity of the screen 115 matches the velocity of the target substrate 110 such that the movement of the target substrate 110 relative to the screen 115 is stationary and the difference in velocity between the movement of the screen 115 and the movement of the target substrate 115 is zero.

With reference to FIGS. 1A-1C and FIGS. 4-5, in a further aspect of the disclosure, in some implementations, one or more components of the patterning system (e.g., blade 105, stencil 109, screen 115, barrier 125, shield 127, rolls 129, rolls 131, etc.,) may be moved independently and/or synchronously with the movement of the other components of the patterning system. In certain implementations, one or more components of the patterning system may be stationary with respect to a conveyed target substrate 110. Further, in some implementations, one or more components of the patterning system may be stationary with respect to a moving screen 115. In one implementation, one or more components of the patterning system may be stationary relative to the movement of the other components of the patterning system. As an example, the screen 115 and the stencil 109 may be configured to be displaced vertically while the blade 105 moves horizontally. As another example, the screen 115 and the stencil 109 may be configured to move longitudinally in the same direction while the blade 105 is configured to move longitudinally in the opposite direction. In some implementations, one or more components of the patterning system may be stationary with respect to a non-moving subject. In some embodiments, the patterning system may be configured as a rotating body or belt having an interior space for receiving dry powder. The interior and exterior surfaces of the rotating body may be defined by top and bottom surfaces of a screen 115, respectively, for transferring and/or patterning the dry powder as described herein. The rotating body may be configured to rotate about an axis, and the direction of rotation of the rotating body may be the same as the direction of movement of the target substrate 110. In some implementations, a squeegee or roll may be selected to replace the blade 105 based on the composition of the dry powder 101 (i.e., powder components).

With reference to FIGS. 1A-1C, in certain implementations, the blade 105 may be configured to move along a longitudinal direction parallel to the motion of the target substrate 110 (X-direction), along a direction vertical to the movement of the target substrate 110 (Z-direction), and along a direction lateral to the movement of the target substrate 110 (Y-direction). Similarly, the other components of the patterning system (e.g., stencil 109, screen 115, barrier 125, shield 127, rolls 129, rolls 131, etc.,) may be configured to move along a longitudinal direction, parallel to the motion of the target substrate 110 (X-direction), along a direction vertical to the movement of the target substrate 110 (Z-direction), and along a direction lateral to the movement of the target substrate 110 (Y-direction). As some examples, in one implementation, the screen 115 may be stationary and the blade 105 and target substrate 110 may be movable. In some implementations, the blade 105 may be stationary relative to the moving target substrate 110. In certain implementations, the screen 115 and target substrate 110 may be moving and the blade 105 may be stationary. In some implementations, the target substrate 110 may be conveyed such that a plurality of patterned dry powder 103 can be deposited continuously onto the upper surface 110A of the target substrate 110. Further, in some implementations, the blade 105 may be configured to move in a direction opposite to the direction of the conveyed target substrate 110. In some implementations, the blade 105 may be configured to move in the same direction of the conveyed target substrate 110, and so forth. In various implementations, the movement and speed of the screen 115 may be configured to match the movement and speed of the target substrate 110. For example, in order to provide continuous printing of patterned dry powder 103 on a conveyed target substrate, the movement and speed of the pattern openings 102 and/or stencil openings 109 may be configured to match the movement and speed of the target substrate 110, In one implementation, transferring a patterned powder 103 to a target substrate 100 in a rotary screen patterning system may include rotating the screen 115 at a predetermined angle while a target substrate 110 is conveyed a predetermined distance, forcing dry powder 101 through the screen 115 onto the target substrate 110 by a blade 105, and then simultaneously moving and positioning the rotary screen 115 and target substrate for transfer of the next patterned powder 103.

In a further aspect of the disclosure, the patterning system may include a controller 114 configured for controlling the movement and operation of each patterning system component. The controller 114 may be programmed to independently adjust and synchronize the XYZ movement and powder deposition rate of powder deposition system 122, the XYZ movement of the blade 105, target substrate 110, and other components of the patterning system, for example, the stencil 109, screen 115, barrier 125, shield 127, the rate/power of operation (e.g., adjusting speed, power, or frequency) and XYZ direction of pre-conditioning devices and post-conditioning devices (as shown in FIGS. 2, 3A-3B, and 8-10C), and so forth. In certain embodiments, the rotational speed (RPM) of the rotating body when the patterning system is configured as a rotating body. These adjustments and synchronizations may include matching the rate of motion in some or all directions such as matching the X motion of the target substrate to the tangential motion of the patterning system, for example, when the patterning system is a rotating body or belt. This matching of motion may be accomplished though programming of the controller 114 and/or by the use of physical contact of portions of the stencil 109 or screen 115 to the target substrate 110. The contact portions may be bottom surfaces of the screen, the stencil, and/or ridges, guides, or plates positioned on the exterior surface of the patterning system. The contact portions may be configured, for example, shaped, smoothed, or coated to minimize friction between the patterned dry powder and the target substrate during transfer of patterned dry powder to the target substrate.

### Offset Printing and Structured Electrode Formation

In many embodiments, the screen printing system may be configured to provide patterned powder to an offset printing system and patterning system. The offset printing and patterning system may include a screen printing system to provide patterned dry powder onto an intermediate substrate to be pressed and heated into a fused patterned layer for battery electrode manufacturing. Some examples, for implementing fused patterned layer include forming structured electrodes or other electrical components using the fused patterned layers. The implementation of screen printing systems as described herein for providing patterned dry powder to a substrate is not restricted by the present disclosure. Further, the patterned powder may include various materials, binders, and additives selected depending on the desired chemistry, application, and method of production. The target substrate, powder materials (powder components), and compositions may be conditioned as part of the printing process. Some examples of offset printing and patterning systems that may be utilized by the apparatus and method of the present disclosure are described in a related application by the Applicant (US Application No. 19/), entitled “Dry Powder Offset Printing,” filed on Jun. 30, 2025, and which is hereby incorporated by reference. The related application describes apparatus, methods, and systems for depositing and processing patterned dry powder on an intermediate substrate using one or more patterning systems. Heat, pressure, radiation, or the like is then applied to the patterned dry powder to form a fuse patterned layer on a target substrate (e.g., a conveyed substrate). In various examples described in the related application, the dry powder is received by a patterning system that is communicably coupled to an intermediate substrate. The patterning system forms a patterned dry powder on an intermediate substrate. The intermediate substrate transports the patterned dry powder to a target substrate. The intermediate substrate and/or target substrate may be configured to apply pressure, heat, radiation, or the like and facilitate transfer of the patterned dry powder onto the target substrate as a fused patterned layer.

### Conditioning, Cleaning, and Directed Energy Devices and Methods

In many embodiments, the patterning system may receive powder and powder components for battery electrode manufacturing. The selection of powder materials and compositions is not restricted by the present disclosure; various materials, binders, and additives may be selected depending on the desired chemistry, application, and method of production. The target substrate, powder materials (powder components), and compositions may be conditioned as part of the printing process. Some examples of pre-/post-conditioning that may be utilized by the apparatus and method of the present disclosure are described in a related application by the Applicant (U.S. application Ser. No. 19/072,702), entitled “Intermediate Surface to Substrate Powder Transfer System and Method,” filed on Mar. 6, 2025, and which is hereby incorporated by reference. The related application describes apparatus, methods, and systems for transferring material such as dry powder from one surface or substrate (e.g., a conveyed or rotating surface or body) to a target substrate (e.g., a conveyed substrate) using a directed energy source, as well as powder cleaning, conditioning, and recycling. In various examples described in the related application, the dry powder and/or dry powder components (e.g., binder, additives, etc.,) may be conditioned by a heating device to apply heat to the dry powder or dry powder composition, an air jetting device to transfer the dry powder or dry powder composition from one surface/substrate to another, a suction/vacuum device to create a pressure differential between the ambient environment and a surface/substrate, one or more spreading or smoothing rollers and/or calenders to smoothen, compact or condition dry powder, a liquid or vapor infusion device to increase cohesion of the dry powder or dry powder composition, a direct energy source to agitate or disrupt an adhesion of the dry powder or dry powder composition, and so forth. In various implementations, one or more conditioning devices may be provided in the patterning system or screen-printing apparatus, to apply heat and/or pressure to activate a binder material contained in the powder composition of the patterned dry powder 103 to form a cohesive dry powder layer on the target substrate 110 (e.g., a current collector web for a battery).

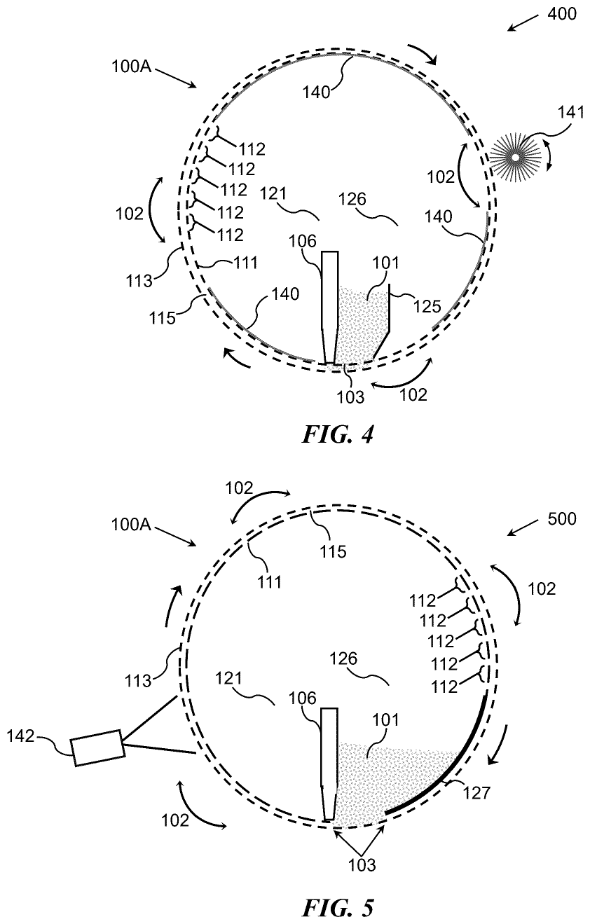

Referring to FIGS. 3A-3B and 4-7, in a further aspect of the disclosure, the patterning system may include a directed energy device 130 configured to be stationary or to move along a longitudinal direction (or a tangential direction to the motion of the rotating body 121), that is, horizontal to the volume enclosed by the movement of the exterior surface of the rotating body 121 (X-direction), along a direction vertical to the movement of the rotating body 121 (Z-direction), and along a direction lateral or axially to the movement of the rotating body 121 (Y-direction). In some embodiments, the directed energy device 130 may be positioned inside the rotating body 121 within an interior cavity 126 of the rotating body 121. In certain implementations, the directed energy device 130 may be positioned externally to the rotating body 121. In some implementations, a plurality of directed energy devices 130 may be implemented and positioned inside the rotating body 121, external to the rotating body 121, or any combination thereof. In some implementations, the directed energy device may be external to the rotating body, but the energy may be directed to the internal region by the use of reflecting devices, mirrors, fiber conduits, waveguides, or other means of direction. The directed energy device 130 may be configured as any one of a vibration device, acoustic energy device, ultrasonic energy device, or other energetic means that can be used to aid fluidization, flow, or transport of the dry powder 101 or separation of the patterned dry powder 103 from the screen during screen separation from the target substrate 110. These can be applied by transducers attached directly or indirectly to the screen, the blade/squeegee, the substrate, substrate support, or from transducers held in proximity to the screen or substrate such as speakers or acoustic actuators. Moreover, with reference to FIGS. 4-5, in various implementations, one or more conditioning devices 141, 142 may be provided adjacent to and exterior from the patterning system or screen-printing apparatus to clean screen 115 and/or stencil 109 of residual dry powder by a brush, roller, air jet, vacuum, or other means between printing.

FIG. 2 illustrates one embodiment of a screen and stencil patterning system with one or more powder conditioning devices for high speed, high precision deposition of patterned dry powder directly onto a target substrate, in accordance with aspects of the present disclosure. In some implementations, an apparatus 200 may include a patterning system 100B, a conveyed target substrate 110 having an upper surface 110A for receiving patterned dry powder 103 thereon, one or more conditioning devices 123, 124, and one or more direct energy devices 130. In certain implementations, an apparatus 200 may include a first spool 150 configured to release the target substrate 110 for processing and a second spool 151 configured to roll in a processed target substrate 110. The apparatus 200 may include one or more conditioning devices 123, 124 positioned upstream from the second spool 151 and one or more conditioning devices 123, 124 positioned downstream from the first spool 150. In some embodiments, the patterning system 100B may include at least one stationary or movable squeegee 106, a screen 115 having a top surface 111 and a bottom surface 113 and one or more screen openings 112 positioned within the screen 115 for receiving dry powder 101, and a pattern blocking layer 140 defining one or more pattern openings 102. The dry powder 101 may be forced into one or more pattern openings 102 (e.g., open areas as defined by pattern blocking layer 140) by the squeegee 106. Each pattern opening 102 containing a plurality of screen openings 112, each screen opening receives, contains, and patterns the dry powder 101 based on the pattern opening 102. The plurality of screen openings 112 may then transfer the patterned dry powder 103 onto the target substrate 110. In an alternate embodiment, the target substrate 110A is a sheet of film, foil, shim, paper, or similar individual or cut substrate conveyed by belts, rollers, or similar apparatuses. In various implementations, the blade 105 presses on the screen 115 to move the bottom surface 113 of the screen 115 to a minimum distance 117C such that the bottom surface 113 contacts the upper surface 110A of the target substrate 110. The minimum distance 117C may be configured to be between 0.05 um to 10 um.

In some implementations, the patterning system 100B may be positioned to be in contact with the target substrate 110 to directly transfer the patterned dry powder 103 onto the target substrate 110. In certain implementations, one or more components (e.g., screen 115, stencil 109, plate 108, etc.,) of the patterning system 100B may be brought into direct contact with the target substrate 110 to directly transfer the patterned dry powder 103 onto the target substrate 110. In certain implementations, the screen is stationary within the patterning system while the target substrate (e.g., current collector web) is in motion. When the portion of the target substrate to be patterned is beneath the screen, the current collector web is stopped, the screen is brought down into contact with the current collector web, and the blade 105 (or squeegee) is made to move and force dry powder through the screen thus forming a printed pattern of the dry powder on the target substrate. The screen is then lifted. Afterwards, the current collector web resumes motion. In one implementation, the screen 115, the bottom surface 113 of the screen 115, the pattern opening 102, the stencil 109, the stencil opening 119, or bottom surface 120 of the stencil opening 119 may be positioned to be in contact with the target substrate 110 to directly transfer the patterned dry powder 103 onto the target substrate 110.

In a further aspect of the disclosure, at least one of the target substrate 110, the upper surface 110A of the target substrate 110, and the lower surface 110B of the target substrate 110 may be conditioned by one or more conditioning devices 123, 124 prior to powder deposition of patterned dry powder 103 thereon. In some implementations, as describe herein, the patterned dry powder 103 may be forced to move vertically onto the target substrate 110 by, for example, the squeegee 106 whereby the squeegee 106 may further force the bottom surface 113 of the screen 115 to contact the upper surface of the target substrate 110. Once the patterned dry powder 103 is positioned on the upper surface 110A of the target substrate 110, one or more conditioning devices 123, 124 may be configured for conditioning the patterned dry powder 103 prior to smoothing, calendering, or other processing, or any combinations thereof. In many implementations, the target substrate 110 may be conveyed to one or more conditioning devices 123, 124 for conditioning the top surface 110A, the bottom surface 110B, or the patterned dry powder 103, or any combinations thereof. In some embodiments, the target substrate 110 may be preheated using one or more heating devices 124 prior to deposition of patterned dry powder 103 thereon. In certain embodiments, the target substrate 110 may be heated subsequent to deposition of patterned dry powder 103 thereon using one or more heating devices 124. In certain implementations, the target substrate 110 and the patterned dry powder 103 may be heated using one or more heating devices 124. In one implementation, the target substrate 110 and patterned dry powder 103 may be heated and pressed using a powder uniformization device 123 which may be a roller, a rod, or a calender applied with a heat source as described herein, or a heated press, a heated roll, or a heated calender.

Moreover, the apparatus 200 may include an energetic device 130 configured to aid fluidization, flow, or transport of the dry powder 101 or facilitate separation of the patterned dry powder 103 from the screen 115/stencil 109/stencil opening 119. Agitating the patterned dry powder 103 can help encourage the dry powder to flow freely through the screen 115 or the stencil opening 119. Vibratory mechanisms can be attached directly or indirectly to the squeegee 106, the screen 115, or the stencil 109. Acoustic devices can also assist in delivering a controlled vibration to the dry powder 101 in the vicinity of the squeegee 106 to help guide or displace dry powder 101 as needed.

FIG. 3A illustrates one embodiment of a screen and stencil patterning system implemented as a rotating body with one or more powder conditioning devices for high speed, high precision deposition of patterned dry powder directly onto a target substrate, in accordance with aspects of the present disclosure. With reference to FIGS. 3A-3B, in some implementations, an apparatus 300 may include a patterning system 100C configured as a rotating body 121 for transferring a patterned dry powder 103 to the target substrate 110. The rotating body 121 may include an interior cavity 126 for receiving dry powder 101 from a powder deposition system 122. In one embodiment, the powder deposition system 122 may be positioned within the interior cavity 126. In some embodiments, the powder deposition system 122 may be positioned adjacent to, or communicably coupled with, the interior cavity 126 to deposit dry powder into the interior cavity 121 through one or more openings 128 on the exterior side surfaces of the rotating body 121. In various implementations, fresh dry powder 101 may be deposited on top of the screen 115 between prints or continuously from any of various powder deposition systems 122 such as hoppers, fluidized powder conveyors, belt conveyors, or other means. In various embodiments, the powder needs to be fed to the top of the screen (interior of the screen for a rotary screen printer). A pneumatic conveying system may be used to transport the dry powder from outside into the interior cavity 126 through a pipe by using the flow of a carrier gas. Use of one or more augers, moving conveyors, vibratory conveyors, or troughs may be used. These can have multiple exit points to evenly distribute the powder over the screen. Fluidic conduits may be used if the powder is fluidized using injected air or other gases with optional vibration to assist in fluidizing the powder inside the conduits.

Further, the patterning system 100C of the apparatus 300 may be configured to enable continuous printing of repeating patterns by implementing a rotating body 121 and conveyed target substrate 110 to continually process, deposit, and transport patterned dry powder 103. In some implementations, the rotating body 121 may include at least one screen 115 having a top surface 111 and a bottom surface 113, and a stencil 109 having one or more stencil openings 119A, 119B positioned along the bottom surface 113 of the screen 115. In certain implementations, where the screen is a non-rotary screen, the screen is stationary within the patterning system while the target substrate (e.g., current collector web) is in motion. When the portion of the target substrate to be patterned is beneath the screen, the target substrate is stopped, the blade 105 (or squeegee) is made to move and force dry powder through the screen, and the screen is brought down into contact with the target substrate. The print is then performed, and the screen is then lifted. Afterwards, the target substrate resumes motion. In some implementations, the stencil 109 may be positioned along the bottom surface 113 of the screen 115 to block dry powder 101 from passing through the bottom surface 113. In certain implementations, the stencil 109 and one or more stencil openings 119A, 119B may be positioned along the bottom surface 113 of the screen 115 to allow dry powder 101 to pass through the screen 115 and into one or more stencil openings 119A, 119B. In some embodiments, the screen 115 may be adhered to the stencil 109 whereby the blade 105 is adjacent to the screen 115 and the target substrate 110 is adjacent to the stencil 109. For example, one or more pattern openings 102 may be aligned with one or more stencil openings 119. Further, in some implementations, the pattern openings 102 may be integrated with the stencil opening 119 whereby the pattern opening 102 is positioned within the terminating surfaces (i.e., the top surface 118 and the bottom surface 120) of the stencil opening 119A, 119B.

Further, in many implementations, the target substrate 110 may be conveyed for receiving patterned dry powder 103 thereon. In certain implementations, the patterning system 100A may include one or more stencil openings 119B having different dimensions from the stencil opening(s) 119A. In certain implementations, the patterning system 100C may include one or more stencil openings 119B having the same dimensions as the stencil opening(s) 119A. Moreover, in certain embodiments, the screen 115 may include one or more stencil openings 119A, 119B spaced apart from one another at a predetermined distance. In many implementations, the apparatus 300 may include a conveying device or mechanism to convey the target substrate 110 to one or more conditioning devices 123, 124. The one or more conditioning devices 123, 124 may be configured for pre-conditioning the target substrate 110 prior to powder deposition of patterned dry powder 103 thereon, or conditioning the patterned dry powder 103 prior to smoothing, calendering, or other processing, or any combinations thereof. In many implementations, the target substrate 110 may be conveyed to one or more conditioning devices 123, 124 for conditioning the top surface 110A, the bottom surface 110B, or the patterned dry powder 103, or any combinations thereof. In one embodiment, one or more condition devices 123 may be a roller having a predetermined diameter defined to be the same or different from the diameter of the rotating body 121. Thus, the exterior surface of the rotating body 121 and conditioning device 123 (roller) may move and enclose the same or different volume. Additionally, when the screen 115/stencil 109/stencil opening 119A, 119B is not in direct contact with the target substrate 110 for transferring patterned dry powder 103, use of a controlled snap-off distance between the screen 115 and the target substrate 110 may be implemented to further control transfer of patterned dry powder 103 through the screen 115/stencil opening 119 and onto the target substrate 110. Other techniques known to those skilled in the art of screen printing such as squeegee speed control, squeegee pressure, snap- off distance, squeegee angle, squeegee stiffness and material of construction may be used to improve the quality and speed of the dry powder printing. Further, because the dry powder 101 in a powder screen printer has unique flow characteristics, traditional rubber or other soft polymeric squeegees are not ideal or suitable. The squeegees should be chosen to be constructed of materials that are not sticky or attracted to the powder. These are often made of Teflon, other fluorinated materials, stainless steel, copper, and other metals. These materials can be coatings or the primary material of squeegee construction. Also, because little force is required to encourage the powder through the screen, very flexible squeegees can be preferred. Thus, thin pieces of metal or hard polymers can be used. In all cases light force can be beneficial.

Referring to FIG. 3B, one embodiment of a screen patterning system is illustrated. The screen patterning system implemented as a rotating body with one or more powder conditioning devices for high speed, high precision deposition of patterned dry powder directly onto a target substrate, in accordance with aspects of the present disclosure. The patterning system 100A of the apparatus 300 may be configured to enable continuous printing of repeating patterns by implementing a rotating body 121 and conveyed target substrate 110 to continually process, deposit, and transport patterned dry powder 103. In some implementations, the rotating body 121 may include at least one screen 115 having a top surface 111 and a bottom surface 113, and one or more powder blocking layers 140 covering the interior surface of the patterning system 100A and defining one or more pattern openings 120. Each pattern opening 120 may include a plurality of screen openings 112 for receiving, containing, patterning, and transferring a patterned dry powder 103 to a conveyed target substrate 110. In certain implementations, where the screen is a non-rotary screen, the screen is stationary within the patterning system while the target substrate (e.g., current collector web) is in motion. When the portion of the target substrate to be patterned is beneath the screen, the target substrate is stopped, the screen is brought down into contact with the target substrate, and the blade 105 (or squeegee) is made to move and force dry powder through the screen performing the print. The screen is then lifted. Afterwards, the target substrate resumes motion.

### Powder Flow Restraint and Containment

FIG. 4 illustrates one embodiment of a screen patterning system with a powder barrier for high speed, high precision deposition of patterned dry powder directly onto a target substrate, in accordance with aspects of the present disclosure. In some implementations, the patterning system 100B may be configured to include at least one squeegee 106, a screen 115 with a plurality of screen openings 112, a pattern blocking layer 140 defining one or more pattern openings 102, and at least one screen barrier 125 spaced apart from and positioned adjacent to the squeegee 106, and a powder cleaning device 141. In some implementations, the patterning system 100B may be configured to include a screen 115 with a plurality of pattern openings 102 positioned along the screen 115 for patterning dry powder 101 and transferring the patterned dry powder 103 to the target substrate 110.

In a further aspect of the disclosure, in certain implementations, the patterning system 100B may be configured to include at least one screen barrier 125 positioned on the screen 115 to contain a volume of dry powder 101 to within a space adjacent to the squeegee 106. In some implementations, the screen barrier 125 may be positioned on or over the top surface 111 of the screen 115 to guide dry powder 101 towards the squeegee 106 and/or one or more pattern openings 102 (i.e., screen openings 112). Further, the screen barrier 125 and pattern blocking layer(s) 140 may be positioned as needed to prevent dry powder 101 from flowing into one or more screen openings 112 or through the top surface 111 of the screen 115.

FIG. 5 illustrates one embodiment of a screen patterning system with a powder shield for high speed, high precision deposition of patterned dry powder directly onto a target substrate, in accordance with aspects of the present disclosure. In some implementations, the patterning system 100B may be configured to include at least one squeegee 106, a screen 115 with a plurality of screen openings 112, a pattern blocking layer 140 defining one or more pattern openings 102, and at least one screen shield 127 spaced apart from and positioned adjacent to the squeegee 106. In many implementations, the patterning system 100B may be configured to include a screen 115 with a plurality of pattern openings 102 placed along the screen 115. In other words, the screen 115 may be configured such that any screen opening 112 between the top surface 111 and the bottom surface 113 of the screen, as defined by the wire mesh lines 104, may be used for patterning dry powder 101 and transferring the patterned dry powder 103 to the target substrate 110.

In a further aspect of the disclosure, in certain implementations, the patterning system 100B may be configured to include a screen shield 127 positioned on the screen 115 to restrain flow of dry powder 101 into the screen 115 and through one or more screen openings 112 directly above the target substrate 110. The screen shield 125 may be configured to act as a powder blocking layer thereby defining a pattern opening 120 between the squeegee 106 and the edge of the screen shield 127 adjacent to the squeegee 106. In some implementations, the screen shield 127 may be positioned on or over the top surface 111 of the screen 115 to prevent dry powder 101 from flowing into one or more screen openings 112 or through the top surface 111 of the screen 115. In certain implementations, the patterning system 100B may be configured to include a screen shield 127 positioned on the bottom surface 113 of the screen 115 to prevent dry powder 101 from flowing out from the bottom surface 113 and/or one or more screen openings 112. Moreover, dry powder 101 that remains past the squeegee 106 can be vacuumed up (cleaned up) with a conditioning device 142 (e.g., vacuum) placed above or below the screen just past the squeegee 106 which would not be practical with pastes or inks.

Since dry powder does not have any surface tension or well-defined viscosity, it may flow too easily through the screen. In some embodiments, where the patterning system utilizes rotary screen printing, it can be a requirement to restrict the powder to free flowing on the screen only in the immediate vicinity of the squeegee. In order to maintain free flow powder and prevent powder from flowing easily through the screen, a screen barrier 125 (screen divider) may be added to the area above the screen and/or a fixed screen shield 127 in close proximity behind the rotating screen in a rotary screen printer.

### Powder Separation

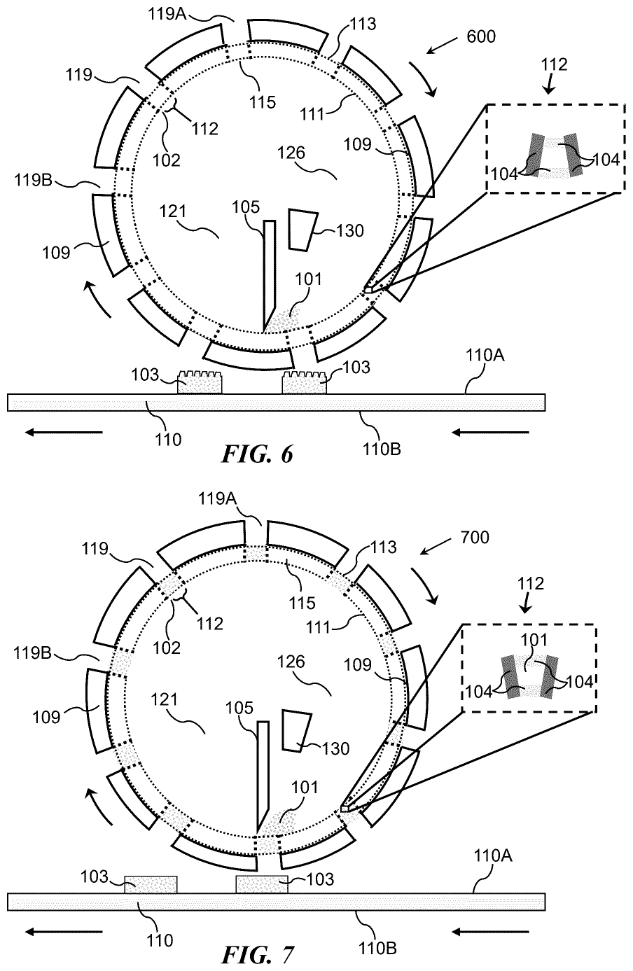

FIG. 6 illustrates one embodiment of a screen and stencil patterning system with flow apertures for high speed, high precision deposition of patterned dry powder directly onto a target substrate, in accordance with aspects of the present disclosure. In various implementations, an apparatus 600 may include a rotating body 121 with an interior cavity 126 for receiving dry powder 101 from a powder distribution system, one or more patterning components including a blade 105, a screen 115, a stencil 109 with one or more stencil openings 119 (119A, 119B), a conditioning device, a cleaning device, an energetic device 130 as described herein for patterning the dry powder 101, one or more separation configurations or separation mechanisms for releasing the adhesion of the dry patterned dry powder 103 from the patterning components of the rotating body 121, and a target substrate 110 for receiving and/or transporting the separated patterned dry powder 103. In some implementations, the separation configuration(s) or separation mechanism(s) further facilitates transfer of dry patterned dry powder 103 onto the target substrate 110. With flow apertures or screen openings 112, the dry powder 101 and patterned dry powder 103 are completely removed from the screen 115 and stencil opening 119 and transferred as a patterned dry powder 103 to the target substrate 110.

In a further aspect of the disclosure, in many implementations, the patterning system may include a stencil 109 having a plurality of stencil openings 119 (119A, 119B), a screen 115 having a plurality of screen openings 112. The screen 115 and screen openings 112 may be positioned to facilitate deposition of a plurality of patterned dry powder 103 or continuous layers of patterned dry powder 103 (as shown in FIGS. 2, 3A-3B, and 6-7). The dimensions of the screen openings 112 and stencil openings 119 (119A, 119B) may be configured to be of the same or different size, shape, and dimension thereby defining the thickness and uniformity of the layer of transferred patterned dry powder 103. The apparatus 600 may include an energetic device 130 configured to facilitate separation of the patterned dry powder 103 from the screen 115/stencil openings 119A, 119B.

In one embodiment, the screen openings 112 of the rotating body 121 may be conical (FIG. 1I) in shape to facilitate release and transfer of patterned dry powder 103 when adjacent to the target substrate 110. The blade 105 may scrape across the screen 115 applying a force to the dry powder 103 forcing it into and through the screen openings 112 and holes into the stencil openings 119A, 119B thereby patterning the dry powder 103. The patterned dry powder 103 may then transfer immediately to the target substrate 110 as the rotating body 121 rotates and the portion lifts away from the target substrate 110. In various implementations, the rotating body 121 may be configured to include an arrangement of screen openings 112 aligned with the stencil openings 119A, 119B whereby the shape of the screen openings 112 are the same as the stencil openings 119A, 119B to control the flowability and separation of the patterned dry powder 103. In some implementations, the rotating body 121 may be configured to include an arrangement of screen openings 112 aligned with the stencil openings 119A, 119B whereby the shape of the screen openings 112 are different from the stencil openings 119A, 119B to control the flowability and separation of the patterned dry powder 103. In various implementations, the shape of the screen openings 112 may be circular, square, rectangular, hexagonal, or other shapes.

FIG. 7 illustrates one embodiment of a screen and stencil patterning system with retaining apertures for high speed, high precision deposition of patterned dry powder directly onto a target substrate, in accordance with aspects of the present disclosure. In various implementations, an apparatus 700 may include a rotating body 121 with an interior cavity 126 for receiving dry powder 101 from a powder distribution system, one or more patterning components including a blade 105, a screen 115, a stencil 109 with one or more stencil openings 119 (119A, 119B), a conditioning device, a cleaning device, and an energetic device as described herein for patterning the dry powder 101, one or more separation configurations or separation mechanisms for releasing the adhesion of the dry patterned dry powder 103 from the patterning components of the rotating body 121, and a target substrate 110 for receiving and/or transporting the separated patterned dry powder 103. In some implementations, the separation configuration(s) or separation mechanism(s) further facilitates transfer of dry patterned dry powder 103 onto the target substrate 110. With retaining apertures or screen openings 112, the dry powder 101 remains in the screen 115 and patterned dry powder 103 within the stencil opening 119 is forced onto the target substrate 110.

In a further aspect of the disclosure, in many implementations, the patterning system may include a stencil 109 having plurality of stencil openings 119 (119A, 119B), a screen 115 having a plurality of screen openings 112. The screen 115 and screen openings 112 may be positioned to facilitate deposition of a plurality of patterned dry powder 103 or continuous layers of patterned dry powder 103 (as shown in FIGS. 2, 3A-3B, and 6-7). The dimensions of the screen openings 112 and stencil openings 119 (119A, 119B) may be configured to be of the same or different size, shape, and dimension thereby defining the thickness and uniformity of the layer of transferred patterned dry powder 103. The apparatus 600 may include an energetic device 130 configured to facilitate separation of the patterned dry powder 103 from the screen 115/stencil openings 119A, 119B.

In one embodiment, the screen openings 112 of the rotating body 121 may be shaped as a funnel (FIG. 1K) to facilitate retention of patterned dry powder 103 withing the funnel shaped screen openings 112 when adjacent to the target substrate 110 improving control of powder deposition from the screen 115 and stencil 109 configuration. The blade 105 may scrape across the screen 115 applying a force to the dry powder 103 forcing it into and through the screen openings 112 and into the stencil openings 119A, 119B thereby patterning the dry powder 103. The patterned dry powder 103 may then transfer immediately to the target substrate 110 as the rotating body 121 rotates and the portion lifts away from the target substrate 110 retaining the powder within the funnel shaped screen openings 112. In various implementations, the rotating body 121 may be configured to include an arrangement of screen openings 112 aligned with the stencil openings 119A, 119B whereby the shape of the screen openings 112 are the same as the stencil openings 119A, 119B to control the flowability and separation of the patterned dry powder 103. In some implementations, the rotating body 121 may be configured to include an arrangement of screen openings 112 aligned with the stencil openings 119A, 119B whereby the shape of the screen openings 112 are different from the stencil openings 119A, 119B to control the flowability and separation of the patterned dry powder 103. In various implementations, the shape of the screen openings 112 may be circular, square, rectangular, hexagonal, or other shapes. Further, in various implementations, the screen openings 112 stencil openings (e.g., apertures) can be shaped to encourage good separation of the powders from the screen 115 onto the target substrate 110. For example, funnel shaped apertures could encourage the powder to separate at the lower interface of the screen as the screen is removed from the substrate. Conversely, conical shaped apertures would encourage the powder within the screen to stay with the substrate as the screen is removed.

### Holding Mechanisms for Printing and Separation of Patterned Dry Powder

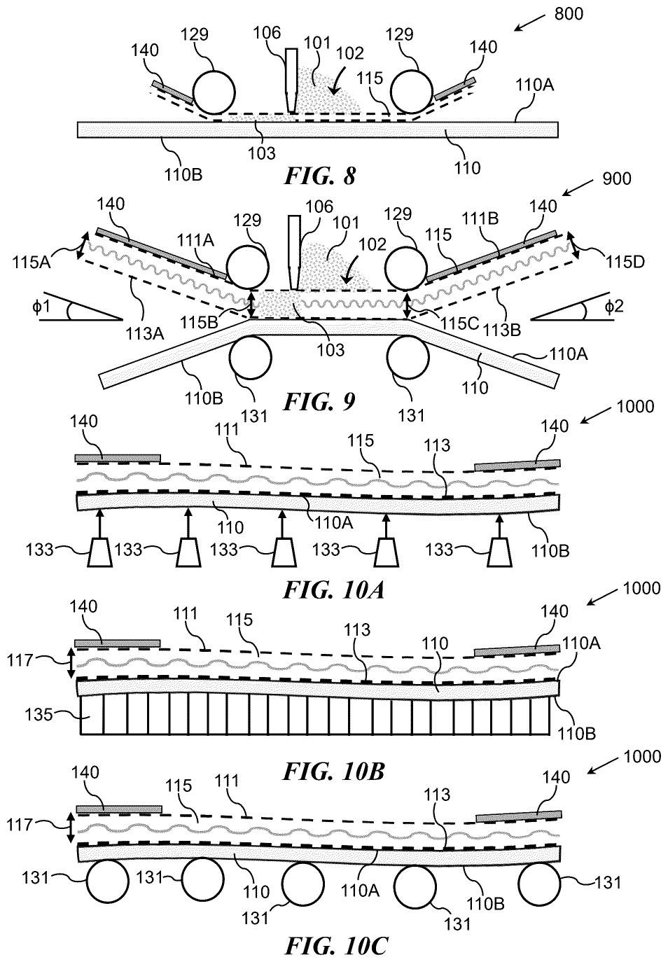

Referring to FIGS. 8-9 and 10A-10C, various holding mechanisms are described which facilitate a powder printing operation of screen and/or stencil printing or transfer of patterned dry powder 103 from the screen 115 and/or the screen 115 and the stencil 109 configuration. Some examples of holding mechanisms are described in FIGS. 8-9 and 10A-10C and are used to illustrate and not limit various methods and devices that may be implemented to position and hold a screen 115/stencil 109 to be in contact with a target substrate 110. One or more holding mechanisms may be implemented as needed to control the position of the target substrate 110 and/or patterning device 800, 900, 1000 to be directly over and in direct contact with one another.

With reference to FIG. 8, in some implementations, a patterning device 800 may include a screen 115 configured to be held in contact with the target substrate 110 for the duration of the powder printing operation. Similarly, one or more stencils 109 may be held in contact to the target substrate 110 for the duration of the powder printing operation when the patterning device is configured to include one or more stencil openings 109 (or a powder blocking layer 140 on the bottom surface 113 of the screen 115) or a screen 115 and stencil 109 combination. The squeegee 106 may then be drawn across the screen 115 to force received dry powder 101 through pattern opening 102 and onto the target substrate 110. In some embodiments, the screen 115 may include a plurality of screen openings 112 positioned adjacent to one another, as well as a plurality of pattern openings 102 spaced apart from one another. In some embodiments, the screen 115 may include a plurality of screen openings 112 positioned end-to-end continuously across the screen 115. In certain implementations, the screen 115 may be held in contact with the target substrate 110 using a plurality of rollers 129. As an example, a pair of rollers 129 (or rods) may be positioned at a distance from each side of the squeegee 106 and configured to press and hold one or more pattern openings 102 (or screen openings 112) of the screen 115 to be in contact or near-contact with the target substrate 110. In some implementations, the distance from the squeegee 106 for each roller 129 of a pair of rollers 129 may be the same or different. In certain implementations, the patterning device 800 may include one or more blades 105 or rollers 129 (or rods) to lead and/or follow the squeegee 106 to hold the screen 115 to be in contact with the target substrate 110 for the duration of the powder printing operation. In some implementations, a magnetic field generating device may be positioned adjacent to a screen 115, a stencil 109, a stencil opening 119, a powder blocking layer 140, or pattern opening 102 to attract and hold one or more pattern openings 102 (or screen openings 112) and/or one or more stencil openings 119 (119A, 119B) to be in contact with the target substrate 110.

With reference to FIG. 9, in some implementations, a patterning device 900 may include a screen 115 having a top surface 111A and a bottom surface 113A that define a first screen thickness 115A at a first distance from a first exterior surface of a squeegee 106, and a top surface 111B and a bottom surface 113B that define a second screen thickness 115B at a second distance from a second exterior surface of the squeegee 106. The patterning device 900 may include a plurality of rollers 129 positioned at a distance from the squeegee 106, each roller 129 configured to press and hold the screen 115 to be in contact with the target substrate 110 for the duration of the powder printing operation. In certain implementations, the thickness of the pattern powder 103 at a first end may be defined by the second screen thickness 115B, deflected by the roller 129 and having a first deflection angle ϕ1. In certain implementations, the thickness of the pattern powder 103 at a second end may be defined by the third screen thickness 115C, deflected by the roller 129 and having a second deflection angle ϕ2. Moreover, the target substrate 110 may be deflected at the corresponding first deflection angle ϕ1 by a first roller 131 (vertically aligned with a first roller 129) and deflected at the corresponding second deflection angle ϕ2 by a second roller 131 (vertically aligned with a second roller 129). The fourth screen thickness 115D positioned opposite to the exterior surface of a roller 129 may be equivalent or less than the first screen thickness 115A or the third screen thickness 115C. In various implementations, the screen 115 may be incompressible and first, second, third, and fourth thicknesses 115A, 115B, 115C, 115D may be the same or significantly the same during operation of blade 105, rollers 129, and rollers 131.

Further, as described above, in certain implementations, the patterning device 900 may include one or more blades 105 or rollers 129, 131 (or rods) to lead and/or follow the squeegee 106 to hold the screen 115 and target substrate 110 to be in contact for the duration of the powder printing operation. Once the screen 115 is held in contact with the target substrate 110, the squeegee 106 may then be drawn across the screen 115 to force received dry powder 101 through pattern opening 102 and screen openings 112 onto the target substrate 110. In some embodiments, the screen 115 may include a plurality of pattern openings 102 spaced apart and positioned adjacent to one another. In some embodiments, the screen 115 may include a plurality of screen openings 112 positioned end-to-end continuously across the screen 115. In various implementations, the first deflection angle ϕ1 may be defined with a range of between 1 degree to 45 degrees. In various implementations, the second deflection angle ϕmay be defined with a range of between 1 degree to 45 degrees. In various implementations, the first, second, third, and fourth screen thicknesses 115A-115D may be defined with a range of between 10 um to 500 um.

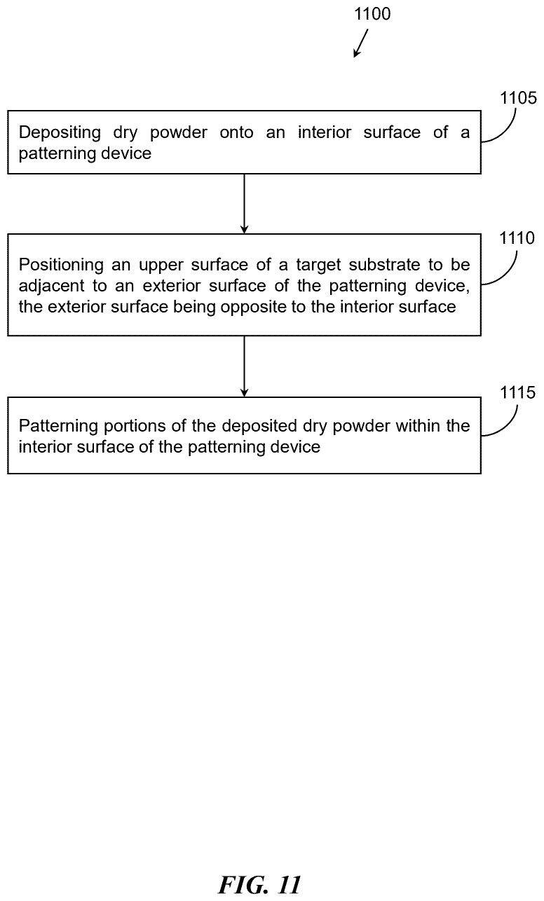

FIG. 10A illustrates one embodiment of a screen patterning system with an example substrate holding mechanism for high speed, high precision deposition of patterned dry powder directly onto a target substrate, in accordance with aspects of the present disclosure. In some implementations, a patterning device 1000 may include an air or fluid pressure device 133 to apply pressure and force on the target substrate 110 to position the target substrate 110 to be in contact with the bottom surface 113 of the screen 115, stencil 109, or screen 115 and stencil 109 configuration.

FIG. 10B illustrates one embodiment of a screen patterning system with an example substrate holding mechanism for high speed, high precision deposition of patterned dry powder directly onto a target substrate, in accordance with aspects of the present disclosure. In some implementations, a patterning device 1000 may include a compliant pad 135 (or compliant roller) to apply pressure and force on the target substrate 110 to position the target substrate 110 to be in contact with the bottom surface 113 of the screen 115, stencil 109, or screen 115 and stencil 109 configuration.

FIG. 10C illustrates one embodiment of a screen patterning system with an example substrate holding mechanism for high speed, high precision deposition of patterned dry powder directly onto a target substrate, in accordance with aspects of the present disclosure. In some implementations, a patterning device 1000 may include a plurality of rollers 131 to apply pressure and force on the target substrate 110 to position the target substrate 110 to be in contact with the bottom surface 113 of the screen 115, stencil 109, or screen 115 and stencil 109 configuration.

### Powder Mixing and Powder Considerations

In many embodiments, the patterning system may receive powder and powder components for battery electrode manufacturing. The selection of powder materials and compositions is not restricted by the present disclosure; various materials, binders, and additives may be selected depending on the desired chemistry, application, and method of production. Some examples of powder compositions that may be utilized by the apparatus and method of the present disclosure are described in a related application by the Applicant (U.S. application Ser. No. 18/391,024), entitled “Electrode Fabrication Process,” filed on Dec. 20, 2023, and which is hereby incorporated by reference. The related application describes a method for manufacturing a battery electrode whereby dry particles are mixed with one or more electrode active materials, conductive additives, and one or more binder materials to form a binder-coated dry powder electrode material. The binder-coated dry powder electrode material can be used for a cathode or an anode. The dry powder electrode material is deposited onto an electrode current collector substrate using a dry powder dispensing device. In various examples described in the related application, the dry powder electrode material is a loose powder that can be poured at speed or mass rate from a dispensing device onto a moving current collector web in a roll-to-roll system. The dry powder electrode material may remain loose on the current collector web after deposition as it travels towards a compaction stage. After being poured onto the current collector, the loose dry powder electrode material is uniformly spread across the width of the moving current collector web by one or more spreading devices. The one or more spreading devices (e.g., conditioning devices) may include a doctor blade, one or more counter-rotating smoothing rollers, and one or more forward-rotating conditioning rollers.

Working with loose dry powders on a moving web prior to compaction is not trivial. Thus, in various examples, the constituent materials of the loose dry powder electrode material are chosen to achieve a balance between flowability and cohesion. The flowability of the loose dry powder electrode material is tuned to allow these materials to readily pour from the dispensing device, yet not too flowable that it scatters upon hitting the moving web or is easily disturbed by the movement and associated vibration of the web. Additionally, an electrode layer must be smooth and uniform in thickness after compaction, and a material that is too flowable does not compact well when calendered. Attempts to compact a highly flowable material with a calender often include streaks in the direction of the moving web as the flowable powder is pushed down the current collector web by the calender or the powder slips. Conversely, if the loose dry powder electrode material is too cohesive, it does not spread well and does not create a smooth and uniform layer when calendered or spread (e.g., there is often separation between individual clumps). Thus, the constituent materials of the loose dry powder electrode material are chosen to achieve a balance between flowability and cohesion. The powder layer, whether used for an electrode of an anode or cathode, must be smooth and uniform in thickness to improve a compaction rate at a calendering stage. In a further aspect of the disclosure, in various implementations, a morphology of a powder material can be tuned to improve adhesion, flowability and cohesion of the powder material on a substrate by improving powder mixing and powder mixture properties as can be achieved using a powder patterning system as described herein.

In one implementation, the powder compositions may be used to form electrode layers using active material particles to form an anode or cathode, using one or more conductive additives, and one or more binder materials may be mixed to form a dry powder electrode material. In one embodiment, the one or more binder materials include 0.5-2 wt % PVDF which is mixed with active material particles and conductive additives. In other embodiments, 2-4 wt % PVDF is used. The active material particles and one or more binder materials, in one embodiment, are dry mixed to achieve a partial coating of PVDF over the active material particles that is between 50 and 85%. Additionally, the dry particles are mixed for a duration and at shear forces sufficient to attach 70-100% percentage of fine binder particles onto the surface of the active material particles to achieve a D50 of 7-12 um to achieve a Hausner ratio between 1.3-1.45.

In various implementations, the dry powder may be produced by dry mixing particles of one or more active electrode materials, conductive additives, and one or more binder materials, constituent materials of the loose dry powder electrode material are chosen to achieve a balance between flowability and cohesion. Examples of dry powder materials used to form a cathode or anode may include, for example and not limited to, carbon black, activated carbon, graphite, graphene, carbon fiber, and carbon nanotubes, copper, aluminum, nickel, silver, pearl graphite, carbon-polymer composite, metal-polymer composite, or combinations thereof. Examples of anode active material include lithium, lithium powder, molten lithium, semi-liquid lithium, lithium titanium oxide, silicon, silicon oxide, hard carbon, graphite, or any combinations thereof. Examples of cathode active material include lithium iron phosphate (LFP), lithium manganese iron phosphate (LMFP), lithium cobalt oxide (LCO), lithium manganese oxide (LMO), lithium nickel cobalt aluminum oxide (NCA), lithium nickel cobalt manganese aluminum oxide (NCMA), lithium nickel manganese cobalt oxide (NMC) and all its variants, lithium nickel manganese oxide (LMNO), lithium vanadium oxide (LVO), lithium iron disulfide, silver vanadium oxide, carbon monofluoride, copper oxide, sulfur, or combinations thereof. As an example, pearl graphite may be selected as a dry powder material for an anode formed by mixing an anode active material (e.g., graphite) with a conductive additive (e.g., conductive carbon) in a first mixing process. The pearl graphite may have sufficient flowability with a particle size of D50 in, for example, a range of 5-20 μm at ˜93 wt %. The conductive carbon, in this example, is 1.5 wt % with a particle size of D50 in the range of 1 nm to <1 μm.

Any suitable mixing process may be used, and multiple mixing processes may be implemented. As an example, a dry powder anode material may be formed by mixing an anode active material (e.g., graphite) with a conductive additive (e.g., conductive carbon) in a first mixing process. In some embodiments, a second mixing process may be performed to mix the graphite/conductive carbon mixture with a binder, for example but not limited to, Polyvinylidene Fluoride (PVDF). In one embodiment, 0.5-5 wt % binder may be used in the mixing process. Alternatively, higher concentrations of 12 wt % binder may also be used. The resulting composite powder has improved dry powder flowability compared with other pure powder, such as NMC by itself.

In one embodiment, a small amount of solvent can be added during the mixing process as a process aid. The solvent may be removed during later stages of the mixing process or immediately after. The result is increased binding efficiency as a result of modifying the shape and structure of the binder. The solvent can be removed through mild heating (80° C.-160° C.), thus “locking in” a modified structure of the binder to create a dry active material powder. This dry active material powder can then be deposited onto a current collector, as an example.

[Full binder coat] In a further aspect of the disclosure, various example implementations of binder material(s) may be utilized in powder engineering a powder material for a desired flowability, cohesion, handleability, and other benefits as described herein. In one implementation, the morphology of a powder material includes coating an active material particle with a binder layer to improve flowability of the material particles. In one embodiment, the dry powder electrode material particle may include an active material particle coated with a binder layer (e.g., Polyvinylidene Fluoride (PVDF)). The binder layer may be produced by dry mixing active material, 0.50-20 wt % binder, and conductive additives. The binder layer may be used to coat, in part or in whole, the surface of active material particle to promote flowability. For example, a relatively higher concentration of binder in loose dry powder electrode material has been shown to result in a balance of flowability and cohesion when mixed using relatively higher shear forces.

[Partial binder coat] In certain embodiments, an example morphology of a dry powder electrode material particle may include a spherical active material particle, such as cathode active material NMC, with partial binder coating. In one embodiment, the partial binder coating may be produced by dry mixing active material, 2 wt % PVDF, and conductive additives at relatively lower shear forces. As an example, a partial binder coating may cover 60-70% of the surface of an active material particle. In some embodiments, partial binder coating may limit the PVDF to being a surface adherent to the active material particles after compaction and binder activation resulting in sufficient space (e.g., voids, cavities, etc.,) between active material particles in the electrode layer for electrolyte penetration whereby flowability is improved but electrochemical properties are limited. In some embodiments, an example morphology of a dry powder electrode material particle may include an amorphous active material particle, such as cathode active material LFP, with partial binder coating.

[Porous binder coat] In some embodiments, an example morphology of a dry powder electrode material particle may include spherical active material particle, such as cathode active material NMC, with porous binder coating. Additionally, the resulting morphology, its porous nature, and spread of the binder layer result, in one embodiment, in an increase in ionic conductivity due to capillary forces that encourage electrolyte penetration toward and access to active material particle. In one embodiment, the porous binder coating may be a matrix of nano PVDF particles (200-500 nm in diameter). The matrix, in one embodiment, may appear as a porous hard-spongelike layer composed of many nano PVDF particles attached to each other surrounding active material particle and can range from areas of no coverage on the surface of active material particle to areas of multiple nano PVDF particles thick. In one embodiment, a porous binder coating may be produced by dry mixing the active material, 2 wt % nano PVDF, and conductive additives at low shear forces. As an example, powder material particles may have a 70-90% binder surface coverage of active material particle. In certain embodiments, an example morphology of a dry powder electrode material particle may include amorphous active material particle, such as cathode active material LFP, with porous binder coating.

In some embodiments, higher shear forces exerted in the mixing of particles can cause the binder (e.g., full binder coating or partial binder coating of the active material particle) to at least partially deform and mold to the surface of the active material particles. Conversely, the relatively lower shear forces may be exerted when mixing dry powder electrode material particle cause the nano PVDF particles (e.g., porous binder coating) to adhere to the surface of active material particle and to each other (to form a three-dimensional matrix of particles) without complete deformation. Accordingly, porous binder coating causes increased friction having a Hausner ratio of roughly 1.38-1.45 and, thus, dry powder electrode material particle with porous binder coating of the active material particle does not flow as well as dry powder electrode material particles with full binder coating or partial binder coating of the active material particle yet can have superior electrochemical properties.

[Hybrid binder coat] In various implementations, any suitable thermoplastic binder compositions other than PVDF binder may be used to produce the dry powder material. In some embodiments, a hybrid binder composition may be used to obtain a desired balance between flowability and cohesion of the dry powder to produce a uniform powder layer. In various implementations, the hybrid binder composition may comprise a thermoplastic binder and a thermally curable binder, a UV curable binder, or two or more UV curable compositions where each binder is cured by UV radiation at a wavelength different from each other. When a hybrid binder comprising one or more of thermoplastic binder, thermally curable binder and UV curable binder is used, one or more of the components of the hybrid binder can be selectively cured or partially cured at a curing station to improve the cohesion and handleability of the dry powder material layer to prevent breaking down of the first layer during flipping through turn rollers.

In one embodiment, the hybrid binder composition may comprise one or more B-stage binder compositions which are partially cured, i.e., in the B-stage state. In various implementations, one or more of the components of the hybrid binder composition can be selectively cured or partially cured to tune the flowability and cohesion of the dry powder during the dry powder mixing process as described above or during a dry powder electrode manufacturing process. In various implementations, a dry powder material manufacturing process may include any suitable lubricating agents including organic materials (e.g., organic solvents) and other materials added to water that may be used to improve the cohesion and uniform compaction of the dry powder material. The amount of lubrication agent applied to the dry powder electrode material can be less than 10 wt %, preferably less than 5 wt %. In another example, the lubricating agent can serve as an activation agent to activate binder curing.

[Other binders] In some embodiments, the binder coated powder may comprise one or more of organic binders or inorganic binders or combinations thereof. The organic binder can comprise either a thermally curable composition, UV curable composition, or a photocurable composition or combinations thereof. In some implementations, the binder may comprise a ceramic precursor, such as polycarbosilane or polysiloxane which can thermally react and become part of the printed object during the post-printing process, e.g., sintering. In various embodiments, the binder coated powder can be made by any of the various particle coating techniques including but not limited to dry mixing, solvent evaporation, spray coating including spray drying and spray congealing, air suspension coating (also termed as fluidized bed coating), pan coating, centrifugal extrusion and multi-orifice centrifugal process, and the like. In various implementations, spray drying may be applied to the particles of the powder to impart fluidity on the powder in addition to, or in lieu of, other powder engineering processes described herein.

[Binder selection and limitations] In various aspects of the disclosure, powder engineering may include selection and configuration of one or more binder materials to hold the particles in place to make a cohesive layer. In many embodiments, application of binder material(s) and binder material amounts may be limited to the contact points between particles thereby limiting the binder contact points to promote sufficient electrolyte penetration into the resulting compacted powder layer (e.g., in a post-calendered electrode layer). There are multiple factors that may encourage the morphology of a dry powder electrode. One factor is the appropriate amount of binder, excessive use of binder would fill an unnecessary volume between particles, yet inadequate use of binder would not ensure sufficient particle to particle adhesion. Another factor is binder particle size; selection of small particles may not congeal as readily as larger agglomerates when melted, causing the binder to remain a surface adherent (i.e., keeping the binder from filling in the cavities between particles). Another factor is mixing intensity or shear force; the shear forces need to be strong enough to enable the binder particles to adhere to the active material particle surface, but not too strong that they deform and melt together and fully coat the particle surface limiting electrolyte penetration. Another factor is calendering pressure and heat; too much pressure and the structure collapses. Accordingly, the resulting morphology of dry powder electrode is a porous structure that, in one embodiment, increases ionic conductivity due to capillary forces that encourage electrolyte penetration toward and access to the active material particle.

### Method for Implementing Screen/Stencil Printing

FIG. 11 illustrates an example flow chart showing a method for facilitating high speed, high precision powder deposition of patterned dry powder directly onto a target substrate using screen and/or stencil printing with precise control of powder size, shape, and uniformity, in accordance with one or more embodiments of the present disclosure. These exemplary methods are provided by way of example, as there are a variety of ways to carry out these methods. Each block shown in FIG. 11 represents one or more processes, methods, or subroutines, carried out in the exemplary method. FIGS. 1A-1K, 2, 3A-3B, 4-9, and 10A-10C show example embodiments of carrying out the method of FIG. 11 for facilitating high speed, high precision powder deposition of patterned dry powder directly onto a target substrate using screen and/or stencil printing with precise control of powder size, shape, and uniformity while minimizing additional processing and components that can reduce the flowability and cohesiveness of the dry powder during the process of powder deposition onto a target substrate. Each block shown in FIG. 11 represents one or more processes, methods, or subroutines, carried out in the exemplary method. The exemplary method may begin at block 1105. Method 1100 may be used independently or in combination with other methods or process for facilitating high speed, high precision powder deposition of patterned dry powder directly onto a target substrate using screen and/or stencil printing with precise control of powder size, shape, and uniformity while minimizing additional processing and components that can reduce the flowability and cohesiveness of the dry powder during the process of powder deposition onto a target substrate. For explanatory purposes, the example process 1100 is described herein with reference to the powder transfer system of FIGS. 1A-1K, 2, 3A-3B, 4-9, and 10A-10C. Further for explanatory purposes, the blocks of the example process 1100 are described herein as occurring in serial, or linearly. However, multiple blocks of the example process 1100 may occur in parallel. In addition, the blocks of the example process 1100 may be performed in a different order than the order shown and/or one or more of the blocks of the example process 1100 may not be performed. Further, any or all blocks of example process 1100 may further be combined and done in parallel, in order, or out of order.

In FIG. 11, the exemplary method 1100 of high speed, high precision powder deposition of patterned dry powder directly onto a target substrate using screen and/or stencil printing with precise control of powder size, shape, and uniformity while minimizing additional processing and components that can reduce the flowability and cohesiveness of the dry powder during the process of powder deposition onto a target substrate, is shown. Method 1100 begins at block 1105. In block 1105, the method includes depositing dry powder onto an interior surface of a patterning device. In block 1110, the method includes positioning an upper surface of a target substrate to be adjacent to an exterior surface of the patterning device, the exterior surface being opposite to the interior surface. In block 1115, the method includes patterning portions of the deposited dry powder within the interior surface of the patterning device.

In some implementations, the method may further include positioning dry powder on a screen, the screen comprising a top and bottom surface and a plurality of openings positioned between the top and bottom surfaces, each opening of the plurality of openings configured to receive a portion of the received dry powder. In certain embodiments, the method may further include positioning a barrier on the interior surface of the screen at a fixed distance from the blade to contain the received powder within a vertical column to facilitate forcing of each portion of dry powder through the interior surface of a corresponding opening of the screen and into the corresponding opening. Moreover, in some embodiments, the method may further include positioning a shield on the bottom surface of the screen at a fixed distance from the blade to restrict the received powder from passing through the bottom surface of the screen to facilitate forcing of each portion of dry powder through the interior surface of a corresponding opening of the screen and into the corresponding opening.

Further, in certain implementations, the method may further include forcing each portion of dry powder through the interior surface of a corresponding opening of the screen and into the corresponding opening thereby patterning each portion of dry powder. The method may include transferring to the upper surface of the target substrate at least one patterned portion of dry powder contained in the corresponding opening of the screen as a patterned dry powder layer. In some embodiments, the method may further include holding and maintaining direct contact between the exterior surface of the patterning device and the upper surface of the target substrate to facilitate transfer directly thereon each patterned portion of dry powder from the corresponding opening of the screen as a patterned dry powder layer. In certain embodiments, the method may include pressing and heating the patterned portion of dry powder onto the upper surface of the target substrate to adhere the patterned dry powder layer thereon. Further, in some implementations, the target substrate is a current collector web, the patterned dry powder layer comprises loose dry powder and a binder, wherein the patterned dry powder layer is heated to activate the binder to adhere the patterned dry powder layer to the current collector web to facilitate cohesion of the dry powder particles and adhesion of the patterned dry powder layer on the upper surface of the current collector web.

It is noted that, although specific examples of processing steps for a printing operation have been illustrated and discussed, the order of the processing steps could be changed, if desired, and/or additional processing steps could be added.

In the following, further features, characteristics, and advantages of the instant application will be described by means of items:

Item 1. An apparatus, comprising: a patterning device including an interior surface and an exterior surface opposite to the interior surface, the interior surface configured to receive dry powder, the exterior surface positioned adjacent to an upper surface of a target substrate; and a powder delivery system communicably coupled with the patterning device to deliver dry powder onto the interior surface of the patterning device; the interior surface of the patterning device comprising: a screen comprising a top and bottom surface and a plurality of openings positioned between the top and bottom surfaces, each opening of the plurality of openings configured to contain a portion of the received dry powder, and a blade configured to be positioned adjacent to the interior surface of the screen to force the portion of dry powder through the top surface of a corresponding opening of the screen and into the corresponding opening thereby patterning each portion of dry powder.

Item 2. The apparatus of claim 1, further comprising a holding mechanism configured to hold and maintain direct contact between the exterior surface of the patterning device and the upper surface of the target substrate to facilitate transfer directly thereon each patterned portion of dry powder contained in the corresponding opening of the screen as a patterned dry powder layer.

Item 3. The apparatus of claim 2, wherein the holding mechanism is configured to hold down the exterior surface of the patterning device to maintain contact to the upper surface of the target substrate using at least one of: a tip of the blade, a tip of a second blade, one or more rollers positioned on the interior surface of the screen, and a magnetic field generator configured to hold the bottom surface of the screen to the upper surface of the target substrate.

Item 4. The apparatus of claim 2, wherein the holding mechanism is configured to hold up the upper surface of the target substrate to maintain contact to the exterior surface of the patterning device using at least one of: one or more rollers positioned on the lower surface of the target substrate opposite to the upper surface, one or more pressurized devices for providing air or fluid pressure, and one or more compliant pads pressed against the lower surface of the target substrate.

Item 5. The apparatus of claim 1, wherein the patterning device is a movable surface comprising an interior volume adjacent to the interior surface, wherein the screen extends along and forms the exterior surface of the movable surface, and wherein the movable surface is configured to move and enclose a volume to enable continuous printing of repeating patterns of the patterned dry powder layer.

Item 6. The apparatus of claim 1, further comprising a powder uniformization device configured to press and heat the patterned portion of dry powder on the upper surface of the target substrate.

Item 7. The apparatus of claim 1, further comprising one or more stencils positioned on the bottom surface of the screen to define the shape and thickness of each patterned portion of dry powder contained transferred to the upper surface of the target substrate as the patterned dry powder layer.

Item 8. The apparatus of claim 7, further comprising a plurality of stencils distributed across the bottom surface of the screen, wherein the thickness and dimensions of at least two stencils of the plurality of stencils differ from one another to facilitate control and variation of the shape and thickness of the patterned dry powder layer formed on upper surface of the target substrate.

Item 9. The apparatus of claim 7, wherein the target substrate comprises a current collector web and the screen and the stencil are adhered together.

Item 10. The apparatus of claim 7, further comprising a cleaning device to remove residual dry powder from at least one of the screen and the stencil.

Item 11. The apparatus of claim 1, further comprising a barrier positioned on the interior surface of the screen and adjacent to the blade, the barrier configured to house the received powder between the blade and the barrier.

Item 12. The apparatus of claim 1, further comprising a shield positioned on the interior surface of the screen and adjacent to the blade to restrict the received powder from passing through the bottom surface of the screen.

Item 13. The apparatus of claim 1, wherein the blade comprises a hard rigid blade configured to completely push the portion of dry powder through the screen and remove dry powder from the interior surface of the screen.

Item 14. The apparatus of claim 1, further comprising an energetic means of transferring energy to the powder, wherein the energetic means is selected from the group consisting of a vibration energy device, an acoustic energy device, and an ultrasonic energy device, and wherein the energetic means is communicably coupled to the screen, the blade, or the target substrate.

Item 15. The apparatus of claim 1, wherein the screen comprises a woven screen.

Item 16. The apparatus of claim 1, wherein the screen comprises a perforated thin sheet, the perforated thin sheet being made of polymer or metal.

Item 17. The apparatus of claim 1, wherein the screen comprises a top surface and a bottom surface, wherein the top surface and bottom surface have different surface roughness.

Item 18. A method, comprising: depositing dry powder onto an interior surface of a patterning device; positioning an upper surface of a target substrate to be adjacent to an exterior surface of the patterning device, the exterior surface being opposite to the interior surface; patterning portions of the deposited dry powder within the interior surface of the patterning device, wherein patterning each portion of deposited dry powder comprises: positioning dry powder on a screen, the screen comprising a top and bottom surface and a plurality of openings positioned between the top and bottom surfaces, each opening of the plurality of openings configured to receive a portion of the received dry powder, forcing each portion of dry powder through the top surface of a corresponding opening of the screen and into the corresponding opening thereby patterning each portion of dry powder; and transferring to the upper surface of the target substrate at least one patterned portion of dry powder contained in the corresponding opening of the screen as a patterned dry powder layer.

Item 19. The method of claim 18, further comprising holding and maintaining direct contact between the exterior surface of the patterning device and the upper surface of the target substrate to facilitate transfer directly thereon each patterned portion of dry powder from the corresponding opening of the screen as a patterned dry powder layer.

Item 20. The method of claim 18, further comprising conveying the target substrate in a longitudinal direction and moving the patterning device in the same direction as the target substrate to enable continuous printing of repeating patterns of the patterned dry powder layer, wherein the patterning device is a roller and the target substrate is a current collector moving tangential to the direction of the roller, and wherein the screen extends along and forms the exterior surface of the roller.

Item 21. The method of claim 18, further comprising pressing and heating the patterned portion of dry powder onto the upper surface of the target substrate to adhere the patterned dry powder layer thereon.

Item 22. The method of claim 20, wherein the target substrate is a current collector web, the patterned dry powder layer comprises loose dry powder and a binder, wherein the patterned dry powder layer is heated to activate the binder to adhere the patterned dry powder layer to the current collector web to facilitate cohesion of the dry powder particles and adhesion of the patterned dry powder layer on the upper surface of the current collector web.

Item 23. The method of claim 18, further comprising cleaning at least one of the screen and the stencil to remove residual dry powder therefrom.

Item 24. The method of claim 18, further comprising transferring energy to the powder using an energetic means selected from the group consisting of vibration energy, acoustic energy, and ultrasonic energy, and wherein the energetic means is communicably coupled to the screen, the blade, or the target substrate.

Item 25. The method of claim 18, further comprising positioning one or more stencils on the bottom surface of the screen to define the shape and thickness of each patterned portion of dry powder transferred to the upper surface of the target substrate as the patterned dry powder layer.

Item 26. The method of claim 18, further comprising positioning a plurality of stencils across the bottom surface of the screen, wherein the thickness and dimensions of at least two stencils of the plurality of stencils differ from one another to facilitate control and variation of the shape and thickness of the patterned dry powder layer formed on upper surface of the target substrate.

Item 27. The method of claim 18, further comprising positioning a barrier on the interior surface of the screen at a fixed distance from the blade to contain the received powder within a vertical column to facilitate forcing of each portion of dry powder through the interior surface of a corresponding opening of the screen and into the corresponding opening.

Item 28. The method of claim 18, further comprising positioning a shield on the bottom surface of the screen at a fixed distance from the blade to restrict the received powder from passing through the bottom surface of the screen to facilitate forcing of each portion of dry powder through the interior surface of a corresponding opening of the screen and into the corresponding opening.

### Definitions

A “powder”, “material deposited,” dry powder “, “dry powder material”, “dry powder electrode”, “dry powder anode”, “dry powder cathode”, “loose powder”, “loose dry powder”, “particle”, “particulate”, “powder material”, or “powder layer” as used herein includes, but is not limited to, any particle or particulate of a dry powder material, dry powder materials, or dry powder compositions that may be altered (e.g., mixed with one or more particles, binders, solvents, conductive additives, or active anode or cathode materials) and/or conditioned through one or more conditioning means to improve flowability, cohesion, and handleability, and are used herein interchangeably. The material deposited may include one or more layers or structures formed, and is not to be limited to electrodes, anodes, or cathodes, and can include any electrical component, surface, or component coating.

A “powder component” as used herein includes, but is not limited to, any of one or more particles, binders, polymers, solvents, conductive additives, or active anode or cathode materials that may be added to a powder. In some implementations, powder components may be selected and added as desired to improve electrical conductivity, flowability, cohesion, electrochemical properties, adhesion, handleability, and conditioning of the powder as well as other benefits as needed.

A “conditioning device,” “conditioning unit,” “processing,” “conditioning,” or “conditioning system,” as used herein, includes, but is not limited to, any apparatus, device, or method that can facilitate smoothing, pressing, heating, compaction, improving adhesion, cohesion, uniformity, compaction, electrochemical properties, or any other characteristic or property of the composite material, composite film, composite layer, substrate, and material deposited (e.g., dry powder and particles, additives, or components of the dry powder composition), and are used herein interchangeably.

A “agitation”, “actuation”, or “vibration” as used herein includes, but is not limited to, any application of mechanical energy to a surface that can emit longitudinal, radial, or transverse waves to disrupt or displace powder or material resting on the surface or impart energy to the powder or material to effectuate motion of the powder or material.

A “rotating body,” or “moving body,” as used herein, includes, but is not limited to, any device configured to facilitate movement of a substrate (or surface) to store, carry, and transport material deposited thereon onto a moving target substrate. As an example, a rotating body can include one or more rollers/rods coupled to one or more bendable or rotatable substrates. The substrate may be a belt, a roll, a flexible substrate, a continuous substrate, a segmented substrate, or a transparent substrate. The rotating body can have a plurality of distinct or segmented surfaces or substrates for receiving materials (e.g., a cog or a spline) whereby the substrate rotates about an axis to facilitate transport of material deposited thereon. The moving target substrate may be located at a distance away from a powder distribution or powder deposition system used to deposit the material onto the substrate.

A “stencil,” or “shape,” as used herein, includes, but is not limited to, patterned powder taking the shape of any letter/character shape (e.g., T, U, H, L, I, or other character shapes, etc.,), any polygonal shape (e.g., a strip, a square, triangle, rectangle, etc.,), or any curved or piece-wise rectilinear shape (e.g., a star shape, etc.,). The powder may be patterned at any stage of processing using any one of a screen, stencil, plate, and wire mesh line, or any combinations thereof as described herein, including the initial stage of depositing a dry powder on a screen or interior surface of the patterning system. Moreover, patterning the powder may include the use of one or more conditioning devices, cleaning devices, and directed energy sources to pattern the powder, and transferring a patterned powder to the target substate.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on. In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional, and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The term “within a proximity”, “a vicinity”, “within a vicinity”, “within a predetermined distance”, “predetermined width”, “predetermined height”, “predetermined length” and the like may be defined between about 0.01 centimeter and about 0.5 meters. The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series, and the like.

The term “a predefined” or “a predetermined” when referring to length, width, height, or distances may be defined as between about 0.01 centimeter and about 0.5 meters.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may. The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. An apparatus, comprising:
a patterning device including an interior surface and an exterior surface opposite to the interior surface, the interior surface configured to receive dry powder, the exterior surface positioned adjacent to an upper surface of a target substrate; and
a powder delivery system communicably coupled with the patterning device to deliver dry powder onto the interior surface of the patterning device;
the interior surface of the patterning device comprising:
a screen comprising a top and bottom surface and a plurality of openings positioned between the top and bottom surfaces, each opening of the plurality of openings configured to contain a portion of the received dry powder, and
a blade configured to be positioned adjacent to the interior surface of the screen to force the portion of dry powder through the top surface of a corresponding opening of the screen and into the corresponding opening thereby patterning each portion of dry powder.

2. The apparatus of claim 1, further comprising a holding mechanism configured to hold and maintain direct contact between the exterior surface of the patterning device and the upper surface of the target substrate to facilitate transfer directly thereon each patterned portion of dry powder contained in the corresponding opening of the screen as a patterned dry powder layer.

3. The apparatus of claim 2, wherein the holding mechanism is configured to hold down the exterior surface of the patterning device to maintain contact to the upper surface of the target substrate using at least one of: a tip of the blade, a tip of a second blade, one or more rollers positioned on the interior surface of the screen, and a magnetic field generator configured to hold the bottom surface of the screen to the upper surface of the target substrate.

4. The apparatus of claim 2, wherein the holding mechanism is configured to hold up the upper surface of the target substrate to maintain contact to the exterior surface of the patterning device using at least one of: one or more rollers positioned on the lower surface of the target substrate opposite to the upper surface, one or more pressurized devices for providing air or fluid pressure, and one or more compliant pads pressed against the lower surface of the target substrate.

5. The apparatus of claim 1, wherein the patterning device is a movable surface comprising an interior volume adjacent to the interior surface, wherein the screen extends along and forms the exterior surface of the movable surface, and wherein the movable surface is configured to move and enclose a volume to enable continuous printing of repeating patterns of the patterned dry powder layer.

6. The apparatus of claim 1, further comprising a powder uniformization device configured to press and heat the patterned portion of dry powder on the upper surface of the target substrate.

7. The apparatus of claim 1, further comprising one or more stencils positioned on the bottom surface of the screen to define the shape and thickness of each patterned portion of dry powder contained transferred to the upper surface of the target substrate as the patterned dry powder layer.

8. The apparatus of claim 7, further comprising a plurality of stencils distributed across the bottom surface of the screen, wherein the thickness and dimensions of at least two stencils of the plurality of stencils differ from one another to facilitate control and variation of the shape and thickness of the patterned dry powder layer formed on upper surface of the target substrate.

9. The apparatus of claim 7, wherein the target substrate comprises a current collector web and the screen and the stencil are adhered together.

10. The apparatus of claim 7, further comprising a cleaning device to remove residual dry powder from at least one of the screen and the stencil.

11. The apparatus of claim 1, further comprising a barrier positioned on the interior surface of the screen and adjacent to the blade, the barrier configured to house the received powder between the blade and the barrier.

12. The apparatus of claim 1, further comprising a shield positioned on the interior surface of the screen and adjacent to the blade to restrict the received powder from passing through the bottom surface of the screen.

13. The apparatus of claim 1, wherein the blade comprises a hard rigid blade configured to completely push the portion of dry powder through the screen and remove dry powder from the interior surface of the screen.

14. The apparatus of claim 1, further comprising an energetic means of transferring energy to the powder, wherein the energetic means is selected from the group consisting of a vibration energy device, an acoustic energy device, and an ultrasonic energy device, and wherein the energetic means is communicably coupled to the screen, the blade, or the target substrate.

15. The apparatus of claim 1, wherein the screen comprises a woven screen.

16. The apparatus of claim 1, wherein the screen comprises a perforated thin sheet, the perforated thin sheet being made of polymer or metal.

17. The apparatus of claim 1, wherein the screen comprises a top surface and a bottom surface, wherein the top surface and bottom surface have different surface roughness.

18. A method, comprising:
depositing dry powder onto an interior surface of a patterning device;
positioning an upper surface of a target substrate to be adjacent to an exterior surface of the patterning device, the exterior surface being opposite to the interior surface;
patterning portions of the deposited dry powder within the interior surface of the patterning device, wherein patterning each portion of deposited dry powder comprises:
positioning dry powder on a screen, the screen comprising a top and bottom surface and a plurality of openings positioned between the top and bottom surfaces, each opening of the plurality of openings configured to receive a portion of the received dry powder,
forcing each portion of dry powder through the top surface of a corresponding opening of the screen and into the corresponding opening thereby patterning each portion of dry powder; and
transferring to the upper surface of the target substrate at least one patterned portion of dry powder contained in the corresponding opening of the screen as a patterned dry powder layer.

19. The method of claim 18, further comprising holding and maintaining direct contact between the exterior surface of the patterning device and the upper surface of the target substrate to facilitate transfer directly thereon each patterned portion of dry powder from the corresponding opening of the screen as a patterned dry powder layer.

20. The method of claim 18, further comprising conveying the target substrate in a longitudinal direction and moving the patterning device in the same direction as the target substrate to enable continuous printing of repeating patterns of the patterned dry powder layer, wherein the patterning device is a roller and the target substrate is a current collector moving tangential to the direction of the roller, and wherein the screen extends along and forms the exterior surface of the roller.

21. The method of claim 18, further comprising pressing and heating the patterned portion of dry powder onto the upper surface of the target substrate to adhere the patterned dry powder layer thereon.

22. The method of claim 20, wherein the target substrate is a current collector web, the patterned dry powder layer comprises loose dry powder and a binder, wherein the patterned dry powder layer is heated to activate the binder to adhere the patterned dry powder layer to the current collector web to facilitate cohesion of the dry powder particles and adhesion of the patterned dry powder layer on the upper surface of the current collector web.

23. The method of claim 18, further comprising cleaning at least one of the screen and the stencil to remove residual dry powder therefrom.

24. The method of claim 18, further comprising transferring energy to the powder using an energetic means selected from the group consisting of vibration energy, acoustic energy, and ultrasonic energy, and wherein the energetic means is communicably coupled to the screen, the blade, or the target substrate.

25. The method of claim 18, further comprising positioning one or more stencils on the bottom surface of the screen to define the shape and thickness of each patterned portion of dry powder transferred to the upper surface of the target substrate as the patterned dry powder layer.

26. The method of claim 18, further comprising positioning a plurality of stencils across the bottom surface of the screen, wherein the thickness and dimensions of at least two stencils of the plurality of stencils differ from one another to facilitate control and variation of the shape and thickness of the patterned dry powder layer formed on upper surface of the target substrate.

27. The method of claim 18, further comprising positioning a barrier on the interior surface of the screen at a fixed distance from the blade to contain the received powder within a vertical column to facilitate forcing of each portion of dry powder through the interior surface of a corresponding opening of the screen and into the corresponding opening.

28. The method of claim 18, further comprising positioning a shield on the bottom surface of the screen at a fixed distance from the blade to restrict the received powder from passing through the bottom surface of the screen to facilitate forcing of each portion of dry powder through the interior surface of a corresponding opening of the screen and into the corresponding opening.
